(19) United States
(12) Patent Application Publication
(10) Pub. No.: US 2005/0116199 A1
(43) Pub. Date: Jun. 2, 2005

(54) Crosslinkable materials for organic light emitting devices and methods

(76) Inventors: Stephen M. Kelly, Beverley (GB); Mary O'Neill, Hull (GB); Matthew P. Aldred, Hull (GB); Panagiotis Vlachos, Hull (GB); Gene C. Koch, Bayville, NJ (US)

Correspondence Address: Ronald D. Trice, PMB 138, 2101 Crystal Plaza Arcade, Arlington, VA, 22202-4600, US

(21) Appl. No.: 10/820,993

(22) Filed: Apr. 9, 2004

Related U.S. Application Data
(60) Provisional application No. 60/461,444, filed on Apr. 9, 2003.

(51) Int. Cl. C09K 19/58; C09K 19/52; C09K 19/38

(52) U.S. Cl. 252/299.01; 252/299.3; 428/1.4

(57) ABSTRACT

The present invention relates to charge transporting or light emitting polymerizable materials having photocrosslinkable dienes. These materials may be polymerized to form charge-transport or light emission layers. The diene substituted materials include small molecules, oligomers, and polymers that are either of liquid crystalline or non-liquid crystalline nature. The present invention also provides materials formed from polymerizing the charge transport or light emitting polymerizable materials, processes of forming the polymers, and devices using the polymers.

### RELATED APPLICATIONS

This application claims priority from, and incorporates by reference, U.S. Provisional application Ser. No. 60/461,444, filed Apr. 9, 2003.

### FIELD OF THE INVENTION

The present invention relates generally to crosslinkable charge transporting or light emitting materials, polymers formed from the same, methods of forming the polymers, and devices using the polymers.

### BACKGROUND

Different types of materials have different properties that often lend themselves to certain application better than other materials. For example, calamitic liquid crystal organic light-emitting device (OLED) charge transport and light emitting materials have a number of properties that may be advantageously used in, for example, display devices as either the display elements or as a backlight. However, for some applications the use of such a material may be disadvantageous or even impossible. Accordingly, there is a need in the art for additional materials that have different properties.

### SUMMARY OF THE INVENTION

The present invention provides charge transport or light emitting polymerizable materials having photocrosslinkable dienes.

The present invention also provides charge transport or light emitting materials formed from the polymerizable charge-transport or light emitting materials.

The present invention also provides a process of photopolymerizing the materials.

The present invention also provides devices formed from a charge transport or light emitting layer.

### BRIEF DESCRIPTION OF THE DRAWINGS

FIG. 1 illustrates an exemplary embodiment including transport layers and emissive layers.

### DETAILED DESCRIPTION

In an aspect, the present invention provides novel charge transporting or light emitting photopolymerizable materials, comprising: reactive non-mesogenic compounds having photocrosslinkable dienes.

In another aspect, the present invention provides suitable reactive non-mesogenic compounds having the following formula:
C—(S-D)ₙ
wherein:
C is a chromophore;
is a spacer;
D is a non-conjugated diene susceptible to photopolymerization; and,
   n is selected from 1, 2, 3, 4, 5, 6, 7, 8, 9, and 10.

Chromophore C may be selected from: aryl substituted fluorene; 4,4′,4″-tris[N-(1-naphthyl)-N-phenyl-amino]triphenylamine; and, bis-triphenylamine, wherein from 0-2 hydrogen atoms on chromophore C are replaced by a group selected from deuterium, F, and CH₃. Aryl substituted fluorene is intended to mean that the fluorene unit is substituted with 1-2 first aromatic rings, which are independently selected from phenyl, naphthyl, and 5-10 membered aromatic heterocycles consisting of carbon atoms and 0-4 heteroatoms selected from O, S, and NH. Examples of heterocycles include, but are not limited to, thienyl, pyridyl, pyridazinyl, pyrimidinyl, pyrazinyl, and triazinyl. Preferably, the first aromatic rings are phenyl or thienyl. It is also preferable that the first aromatic rings are themselves independently substituted with a second aromatic ring. The second aromatic rings are independently selected from phenyl, naphthyl, and 5-10 membered aromatic heterocycles consisting of carbon atoms and 0-4 heteroatoms selected from O, S, and NH. Preferably, the second aromatic rings are phenyl or thienyl. Both the first and second aromatic rings may be substituted with 0-2 groups selected from C₁₋₁₂ alkyl (branched or linear), C₁₋₁₂ alkenyl (branched or linear), C₁₋₁₂ alkoxy (linear or branched), phenyl, naphthyl, bi-phenyl, and thienyl. Spacer S may be an alkylene (linear or branched) or alkenylene (linear or branched) group having 2, 3, 4, 5, 6, 7, 8, 9, 10, 11, 12, 13, 14, or 15 carbon atoms. From 0, 1, 2, to 3 of the carbon atoms of spacer S are replaced by a heteroatom selected from O, S, and NR, wherein R is selected from H, CH₃, C₂H₅, n-C₃H₇, and i-C₃H₇, preferably CH₃, C₂H₅, n-C₃H₇, and i-C₃H₇. From 0, 1, to 2 carbon atoms of spacer S may be substituted by a carbonyl group. Diene D may be selected from: 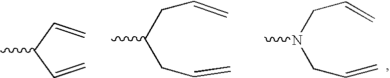
provided that D forms other than an O—N, S—N, or N—N bond with spacer S. Variable n may be selected from 2, 3, 4, 5, and 6.

The terms alkyl, alkylene, alkenyl, and alkenylene, unless otherwise specified, include both linear and branched groups having the defined number of carbon atoms.

In another aspect, the present invention provides novel reactive non-mesogenic compounds of formula I: 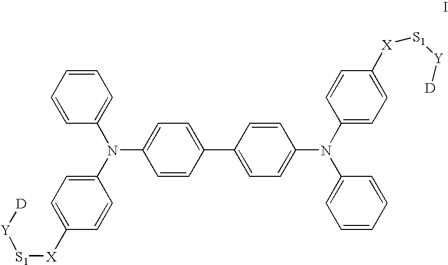
wherein:
each X is independently selected from CH₂O, CH₂, and CH₂NR, wherein R is selected from H, CH₃, C₂H₅, n-C₃H₇, and i-C₃H₇; preferably CH₂O;
each S₁ is independently selected from an alkylene group (linear or branched) and an alkenylene group (linear or branched) having 2, 3, 4, 5, 6, 7, 8, 9, 10, or 11 carbon atoms;
each Y is independently selected from CH₂, O, CO₂, and S; preferably CO₂ and,
each D is independently selected from: 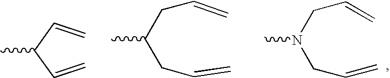
   provided that D forms other than an O—N, S—N, or N—N bond with spacer S.

Examples of X—S₁—Y-D may be selected from:

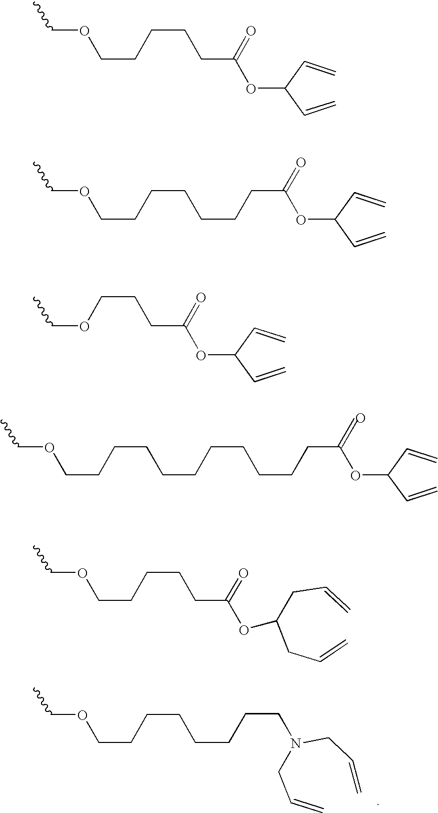

Examples of a reactive non-mesogenic compound include the compound of formula II:

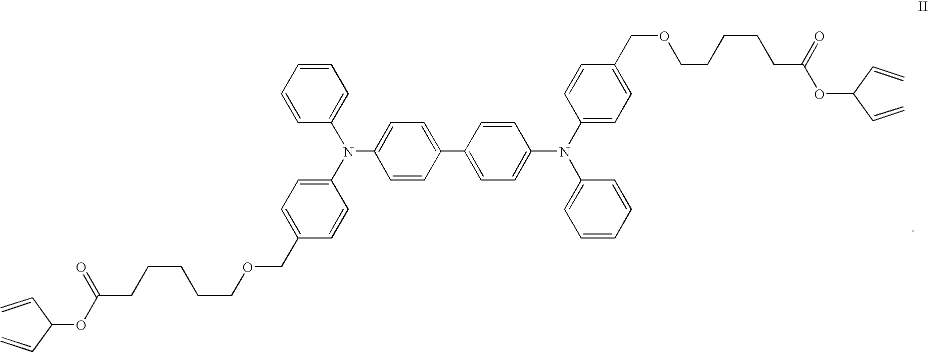

Compounds of formula I and formula II (wherein n=5) could be prepared as shown in the following scheme.

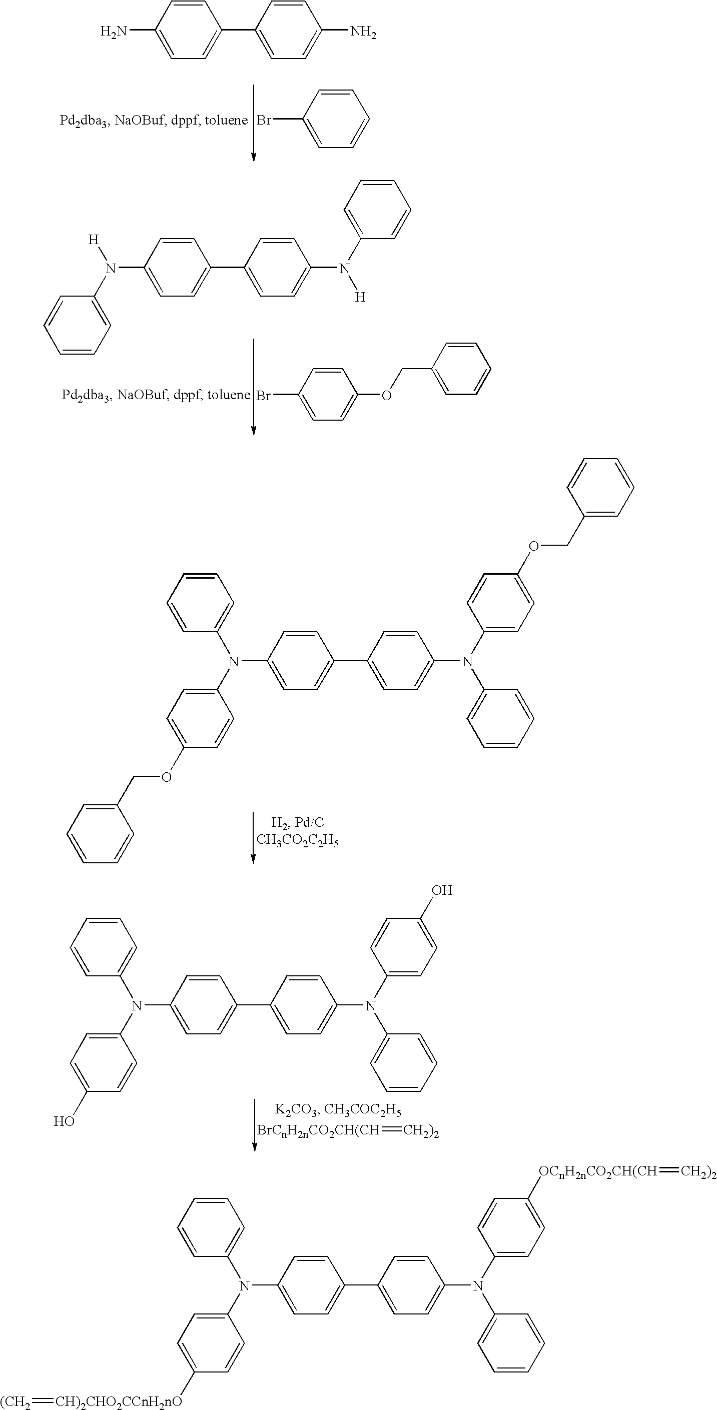

In another aspect, the present invention provides novel reactive non-mesogenic compounds of formula III: 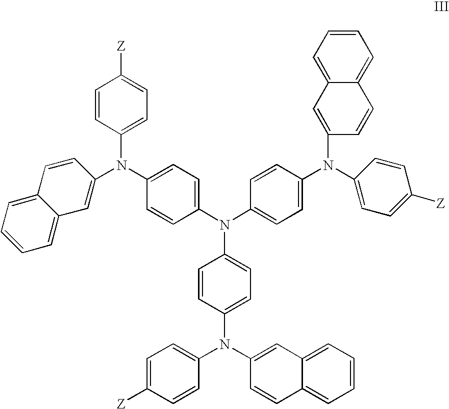
wherein:
each Z is independently selected from X—S₁—Y-D and H, provided that only one Z is H;
each X is independently selected from CH₂O, CH₂, and CH₂NR, wherein R is selected from H, CH₃, C₂H₅, n-C₃H₇, and i-C₃H₇; preferably CH₂O;
each S₁ is independently selected from an alkylene group (linear or branched) and an alkenylene group (linear or branched) having 2, 3, 4, 5, 6, 7, 8, 9, 10, or 11 carbon atoms;
each Y is independently selected from CH₂, O, CO₂, and S; preferably CO₂ and,
each D is independently selected from: 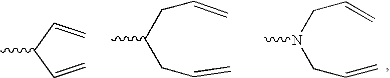
   provided that D forms other than an O—N, S—N, or N—N bond with spacer S.

Examples of a reactive non-mesogenic compound also include the compound of formula IV:

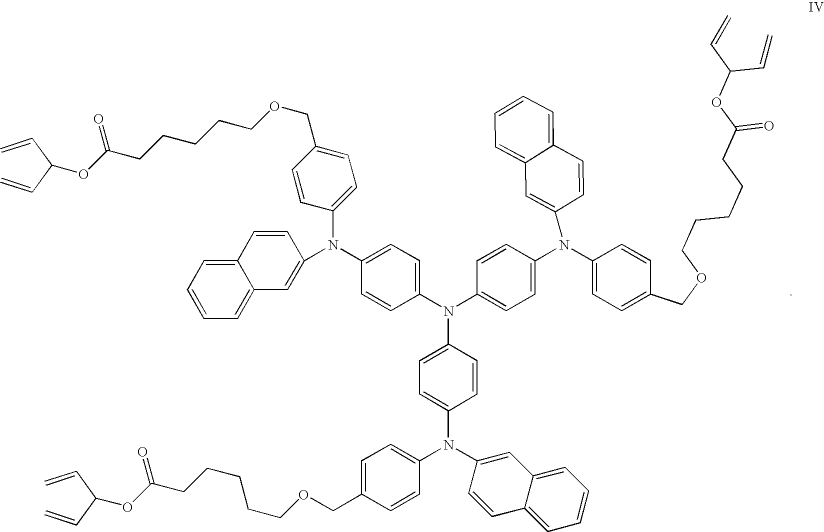

In another aspect, the present invention provides novel reactive non-mesogenic compounds of formula V: 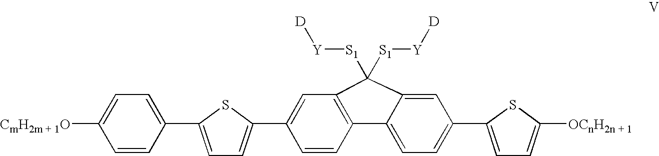
wherein:
each S₁ is independently selected from an alkylene group (linear or branched) and an alkenylene group (linear or branched) having 2, 3, 4, 5, 6, 7, 8, 9, 10, or 11 carbon atoms;
each Y is independently selected from CH₂, O, CO₂, and S; preferably CO₂;
each D is independently selected from: 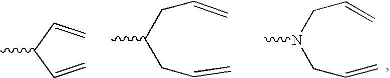
   provided that D forms other than an O—N, S—N, or N—N bond with spacer S;
m is selected from 3, 4, 5, 6, 7, 8, 9, 10, and 11; and,
n is selected from 3, 4, 5, 6, 7, 8, 9, 10, and 11.

Examples of S₁—Y-D may be selected from:

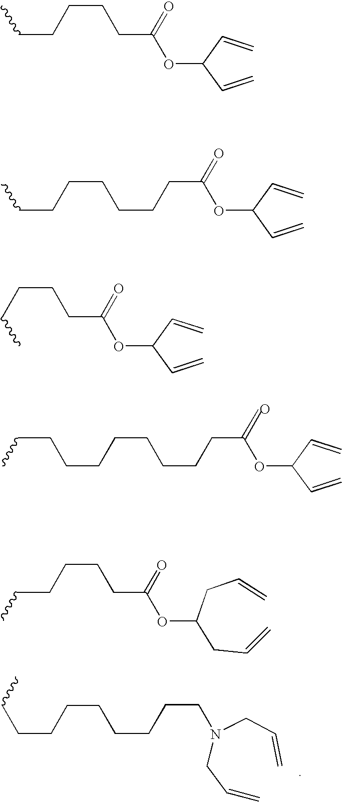

Examples of a reactive non-mesogenic compounds also include the compound of formula VI:

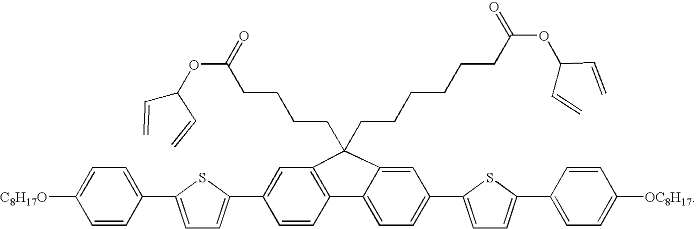

Additional examples of reactive non-mesogenic compounds are shown in Table 1:

TABLE 1

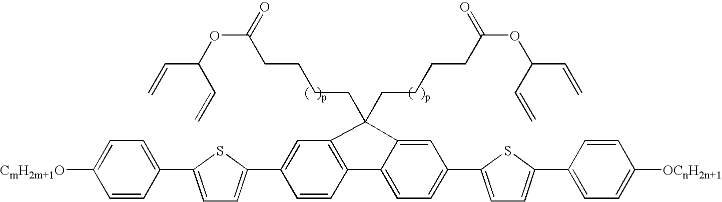

| Formula | p | m | n |
|---|---|---|---|
| VIIa | 2 | 8 | 8 |
| VIIb | 4 | 8 | 8 |
| VIIc | 8 | 8 | 8 |
| VIId | 1 | 3 | 3 |
| VIIe | 1 | 4 | 4 |
| VIIf | 1 | 5 | 5 |
| VIIg | 1 | 6 | 6. |

Compounds of formula V-VIII could be prepared as shown in the following scheme.

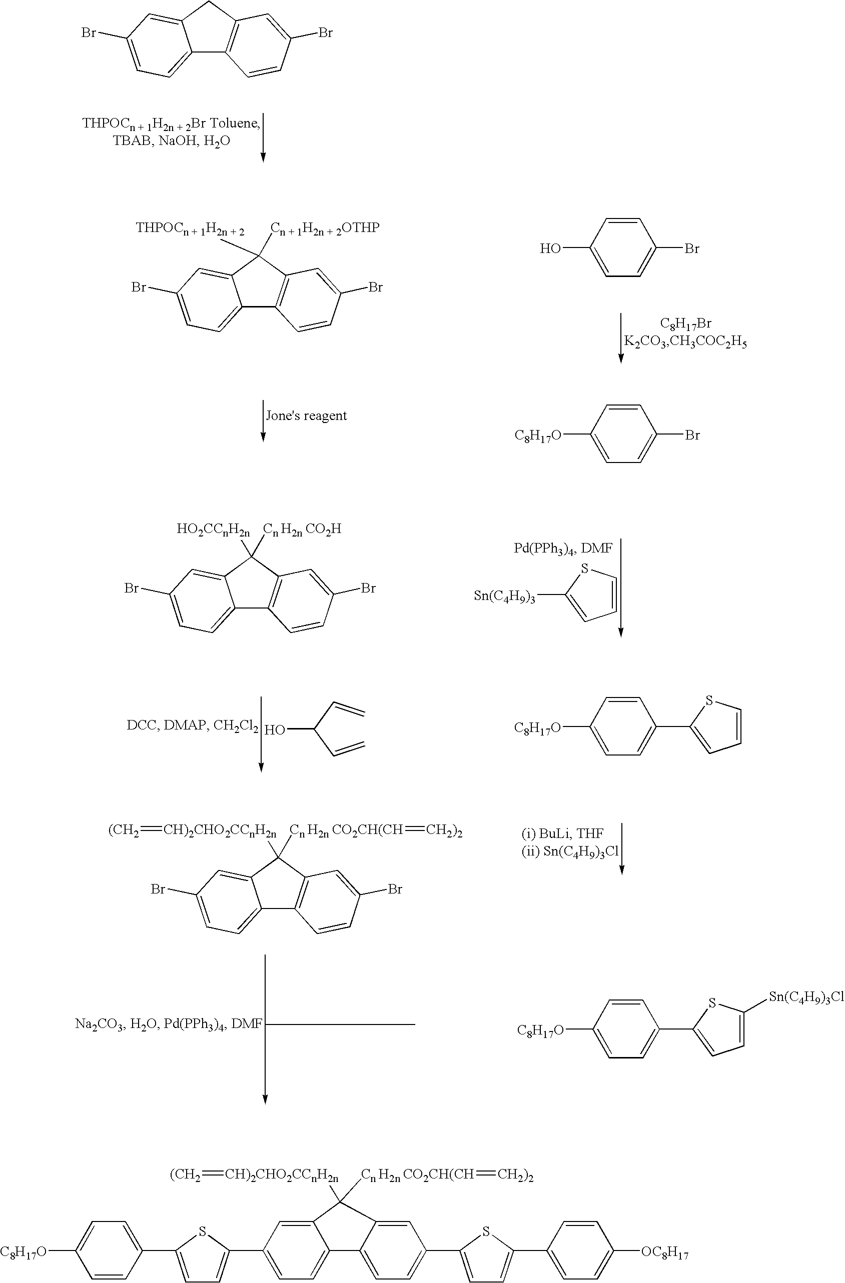

In another aspect, the present invention provides novel reactive non-mesogenic compounds of formula VIII: 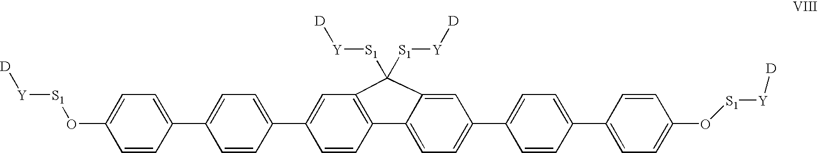
wherein:
each S₁ is independently selected from an alkylene group (linear or branched) and an alkenylene group (linear or branched) having 2, 3, 4, 5, 6, 7, 8, 9, 10, or 11 carbon atoms;
each Y is independently selected from CH₂, O, CO₂, and S; preferably CO₂; and,
each D is independently selected from: 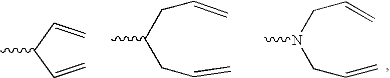
   provided that D forms other than an O—N, S—N, or N—N bond with spacer S.

Examples of a reactive non-mesogenic compounds also include the compound of formula IX

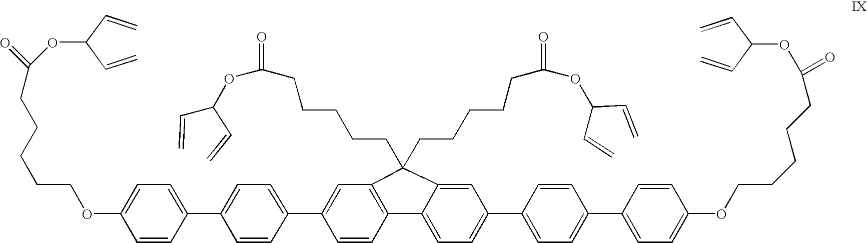

Additional examples of reactive non-mesogenic compounds are shown in Table 2

TABLE 2

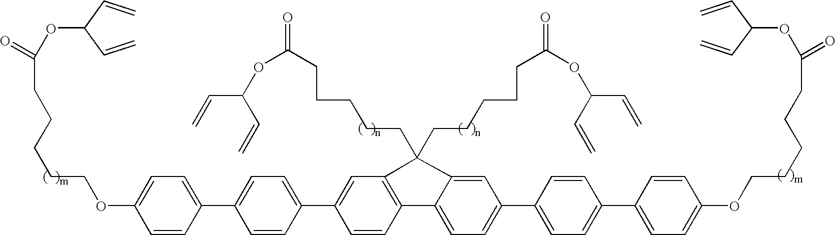

| Formula | n | m |
|---|---|---|
| Xa | 1 | 3 |
| Xb | 1 | 7 |
| Xc | 3 | 1 |
| Xd | 3 | 3 |
| Xe | 3 | 7 |
| Xf | 7 | 1 |
| Xg | 7 | 3 |
| Xh | 7 | 7. |

In another aspect, the present invention provides novel reactive non-mesogenic compounds of formula Va: 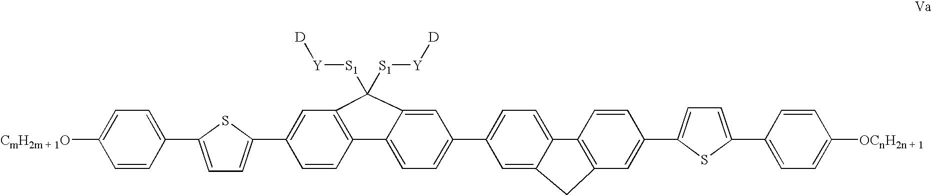
wherein:
each S₁ is independently selected from a C₂₋₁₁ alkylene group and a C₂₋₁₁ alkenylene group;
each Y is independently selected from CH₂, O, CO₂, and S; preferably CO₂; and,
each D is independently selected from: 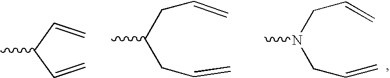
   provided that D forms other than an O—N, S—N, or N—N bond with spacer S.
m is selected from 3, 4, 5, 6, 7, 8, 9, 10, and 11; and,
n is selected from 3, 4, 5, 6, 7, 8, 9, 10, and 11.

Examples of reactive non-mesogenic compounds also include the compound of formula Vb:

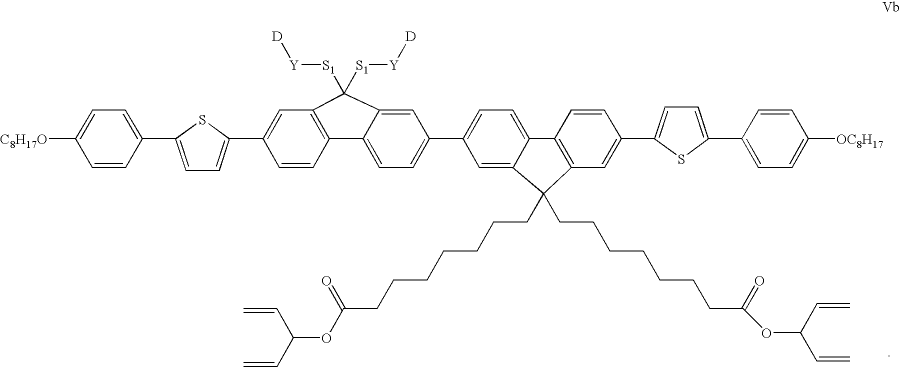

In another aspect, the present invention provides a novel light emitting polymerizable material, comprising: a reactive discotic emitter compound having the following formula:
C—(S-D₁)ₙ
wherein:
C is a chromophore capable of forming a discotic liquid crystal;
S is a spacer;
   D₁ is H or is a non-conjugated diene susceptible to photopolymerization, provided that at least 2 D₁ are other than H; and,
   n is selected from 2, 3, 4, 5, 6, 7, 8, 9, 10, 11, 12, 13, 14, 15, 16, 17, 18, 19, and 20.

Chromophore C may be a phthalocyanine or porphyrin. The phthalocyanine or porphyrin may be bound to a metal. Spacer S may be an alkylene group (linear or branched) or alkenylene group (linear or branched) group having 2, 3, 4, 5, 6, 7, 8, 9, 10, 11, 12, 13, 14, 15, 16, 17, 18, 19, 20, or 21 carbon atoms. From 0, 1, 2, to 3 of the carbon atoms of spacer S are replaced by a heteroatom selected from O, S, and NR, wherein R is selected from H, CH₃, C₂H₅, n-C₃H₇, and i-C₃H₇, preferably CH₃, C₂H₅, n-C₃H₇, and i-C₃H₇. From 0, 1, to 2 carbon atoms of spacer S may be substituted by a carbonyl group. Diene D₁ may be H or selected from: 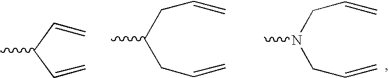
provided that D₁ forms other than an O—N, S—N, or N—N bond with spacer S, and further provided that at least 2 D₁ are other than H. Variable n may be selected from 4, 5, 6, 7, and 8.

In another aspect, the present invention provides novel reactive discotic emitter compounds of formula XI: 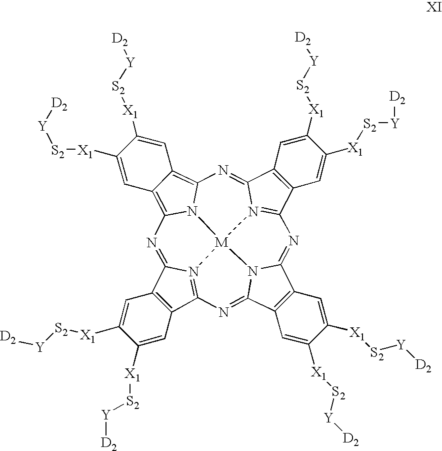
wherein:
M is a suitable metal; preferably Pt;
each X₁ is independently selected from O, CH₂, and NR, wherein R is selected from H, CH₃, C₂H₅, n-C₃H₇, and i-C₃H₇; preferably 0;
each S₂ is independently selected from an alkylene group (linear or branched) and an alkenylene group (linear or branched) having 2, 3, 4, 5, 6, 7, 8, 9, 10, 11, or 12 carbon atoms;
each Y is independently selected from CH₂, O, CO₂, and S; preferably CO₂; and,
each D₂ is independently C₁₋₆ alkyl (linear or branched) or is selected from: 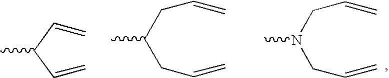
   provided that D₂ forms other than an O—N, S—N, or N—N bond with spacer S, and further provided that at least two D₁ are other than alkyl.

Examples of X₁—S₂—Y-D₂ may be selected from:

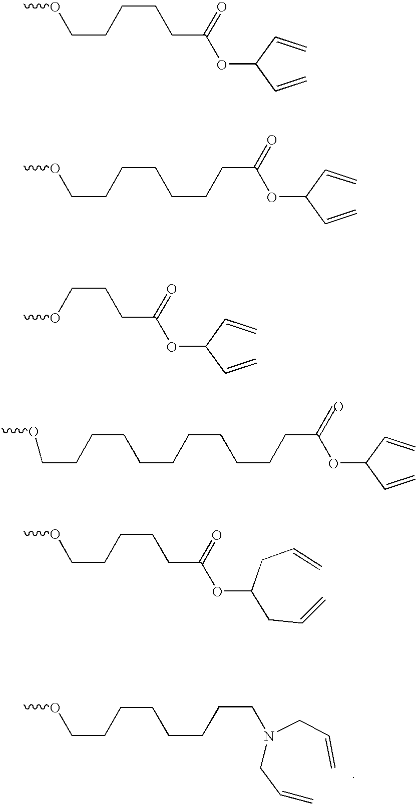

Examples of a reactive discotic emitter compounds include the compound of formula XII:

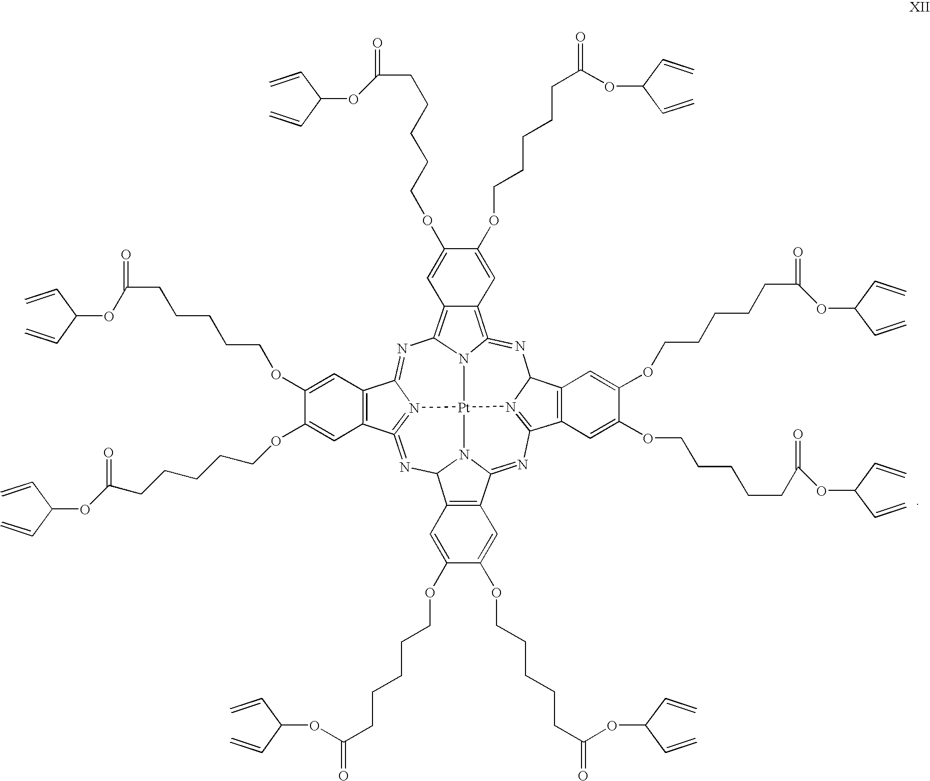

Additional examples of reactive discotic compounds are shown in Table 3

TABLE 3

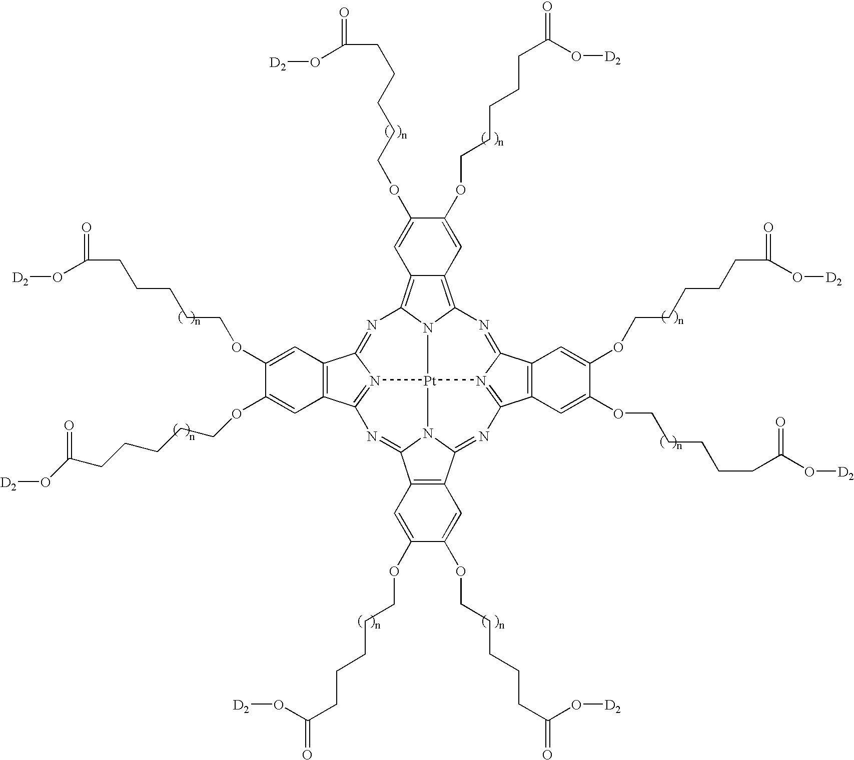

| Formula | n | D₂ |
|---|---|---|
| XIIIa | 1 | B |
| XIIIb | 1 | E |
| XIIIc | 2 | A |
| XIIId | 2 | B |
| XIIIe | 2 | E |
| XIIIf | 3 | A |
| XIIIg | 3 | B |
| XIIIh | 3 | E |

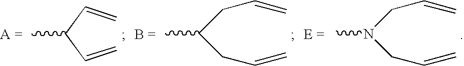

Compounds of formulae XI-XIII could be prepared as shown in the following scheme.

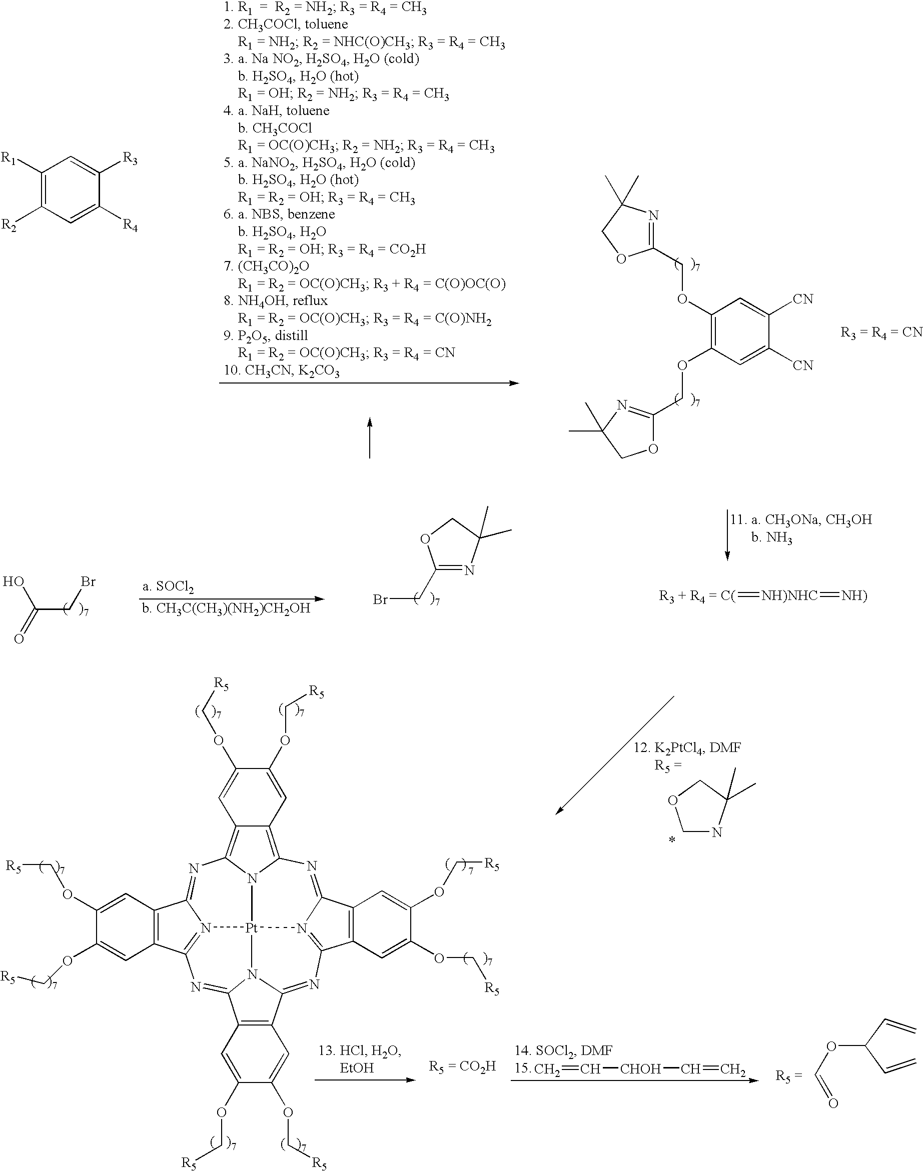

In another aspect, the present invention provides a novel light emitting polymerizable material, comprising: a reactive oligomeric or polymeric compound having the following formula:
—[Ar¹—(S-D)_{q}]ₙ-[Ar²—(S-D)ₚ]ₘ-
wherein:
Ar¹ is a first aromatic group;
Ar² is a second aromatic group;
each S is independently a spacer;
each D is independently a non-conjugated diene susceptible to photopolymerization;
p is selected from 0, 1, 2, 3, 4, 5, 6, 7, 8, 9, and 10; preferably p is 2;
q is selected from 0, 1, 2, 3, 4, 5, 6, 7, 8, 9, and 10; preferably q is 0;
n is a mole fraction of [Ar¹—(S-D)_{q}] in the oligomeric or polymeric backbone of from 0, 1, 2, 3, 4, 5, 10, 15, 20, 25, 30, 35, 40, 45, 50, 55, 60, 65, 70, 75, 80, 85, to 90%;
m is a mole fraction of [Ar²—(S-D)ₚ] in the oligomeric or polymeric backbone of 100−n %; and,
there are about 2, 3, 4, 5, 6, 7, 8, 9, 10, 20, 30, 40, 50, 60, 70, 80, 90, 100, 110, 120, 130, 140, 150, 160, 170, 180, 190, to 200 repeat units in the oligomeric or polymeric backbone, preferably, there are about 2, 3, 4, 5, 6, 7, 8, 9, 10, 20, 30, 40, 50, 60, 70, 80, 90, to 100 repeat units, and more preferably, there are about 20, 22, 24, 28, 30, 32, 34, 36, 38, 40, 42, 44, 46, 48, to 50 repeat units;
provided that p+q total at least 1;
further provided that when n is 0% then p is other than 0.

The oligomeric or polymeric compounds may be copolymers with two repeat units. Alternatively, the copolymers may have 3, 4, 5, or more repeat units. The copolymers may be random-sequence copolymers or ordered sequence copolymers (e.g., alternating or block). Ar¹ and Ar² may be selected from fluoren-diyl and bithien-diyl, preferably fluoren-2,7-diyl and 2,2′-bithien-5,5′-diyl. Spacer S is an alkylene group (linear or branched) or alkenylene group (linear or branched) group having 2, 3, 4, 5, 6, 7, 8, 9, 10, 11, 12, 13, 14, or 15 carbon atoms. From 0, 1, 2, to 3 of the carbon atoms of spacer S are replaced by a heteroatom selected from O, S, and NR, wherein R is selected from H, CH₃, C₂H₅, n-C₃H₇, and i-C₃H₇, preferably CH₃, C₂H₅, n-C₃H₇, and i-C₃H₇. From 0, 1, to 2 carbon atoms of spacer S are substituted by a carbonyl group. Diene D may be selected from: 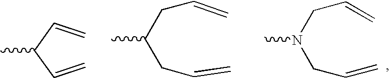
provided that D forms other than an O—N, S—N, or N—N bond with spacer S.

In another aspect, the present invention provides novel reactive oligomeric or polymeric compounds of formula XIV: 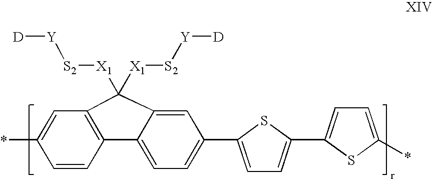
wherein:
each X₁ is independently selected from O, CH₂, and NR, wherein R is selected from H, CH₃, C₂H₅, n-C₃H₇, and i-C₃H₇; preferably 0;
each S₂ is independently selected from an alkylene group (linear or branched) and an alkenylene group (linear or branched) having 2, 3, 4, 5, 6, 7, 8, 9, 10, 11, or 12 carbon atoms;
each Y is independently selected from CH₂, O, CO₂, and S; preferably CO₂;
each D is independently selected from: 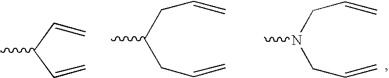
   provided that D forms other than an O—N, S—N, or N—N bond with spacer S;
each * is independently selected from H, OH, C₁₋₁₂ alkyl (linear or branched), C₁₋₁₂ alkoxy (linear or branched), and X₁—S₂—Y-D; and,
r is selected from 2-100, preferably from 20-50.

Examples of X₁—S₂—Y-D are selected from:

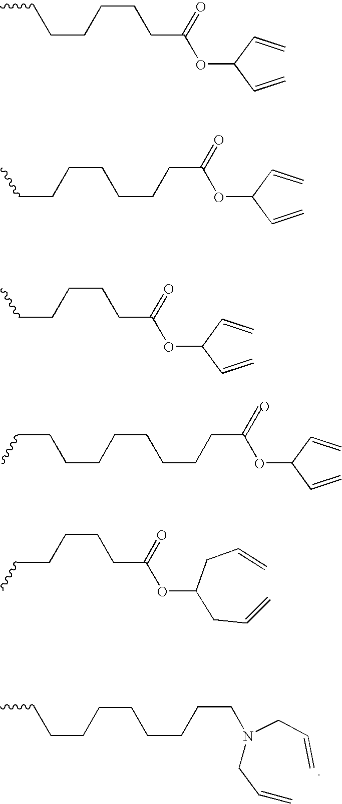

Examples of a reactive oligomeric or polymeric compound include those of formula XV: 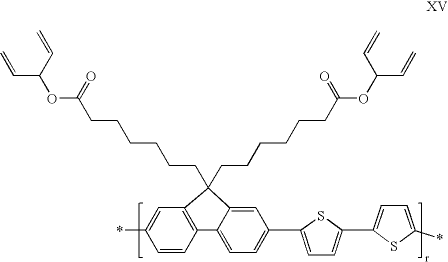
wherein:
each * is independently selected from H, OH, C₁₋₁₂ alkyl (linear or branched), C₁₋₁₂ alkoxy (linear or branched), and 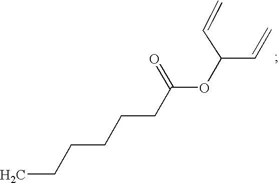
   and, r is selected from 2-100, preferably 20-50.

Compounds of formula XIV-XV could be prepared as shown in the following scheme.

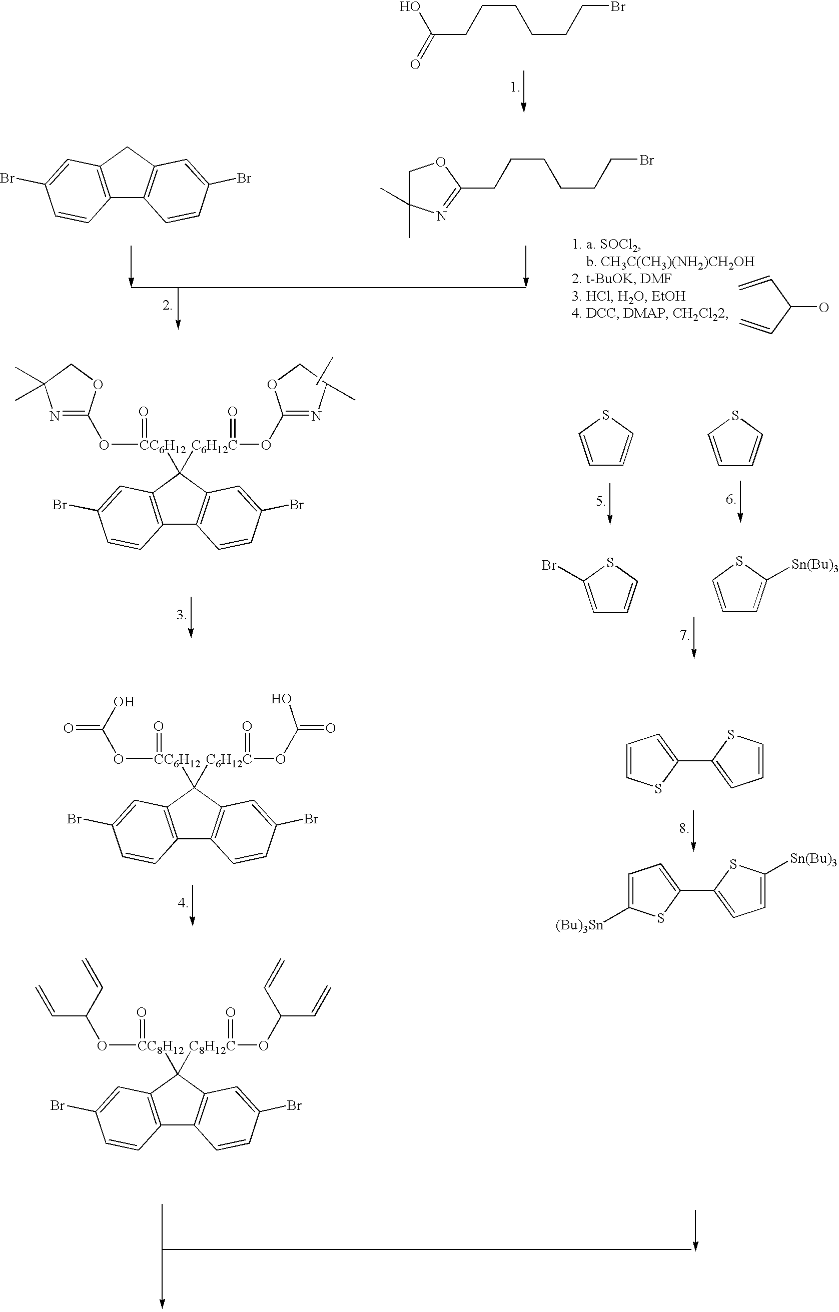

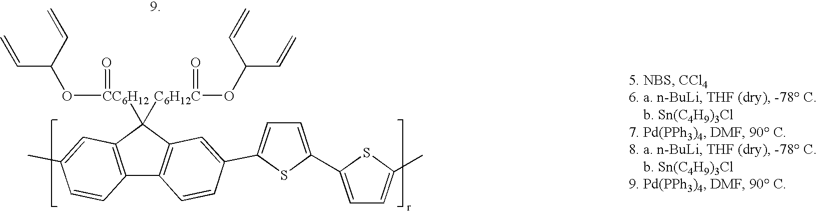

In another aspect, the present invention provides a novel process for forming a charge-transport or light emitting layer, comprising: photopolymerizing the non-conjugated diene moieties of the materials of the present invention. Preferably, the photopolymerization occurs substantially without a photoinitiator. Preferably, the photopolymerization involves cyclopolymerization. The photopolymerizing may be conducted at room temperature. The photopolymerization may also utilize UV radiation.

The photopolymerization may involve radicalization of at least one of the dienes D (or D₁) present in the materials of the present invention to form a radical, D*. The radicalized diene D* may then react with an unradicalized diene D (or D₁) of a second compound to form a cyclic entity. This reaction may be sterically controlled. Preferably, radicalization is caused by UV photopolymerization.

In another aspect, the present invention provides novel, polymeric light emitting or charge transporting materials, comprising: a polymer formed from one of the present charge transporting or light emitting materials. The polymer may have 5, 6, 7, 8, 9, 10, 15, 20, 25, 30, 35, 40, 45, to 50 monomeric subunits. The polymer may be preferably formed by photopolymerization. The polymer may be substantially photoinitiator free. The polymer may be an insoluble, crosslinked network. Crosslinking occurs whenever at least a second diene present on the polymerizable material is attached to a polymer chain formed from polymerizable materials other than that to which the first diene is directly attached. Crosslinking may occur with from 0, 5, 10, 15, 20, 25, 30, 35, 40, 45, 50, 55, 60, 65, 70, 75, 80, 85, 90, 95, to 100% of the polymerizable materials. Preferably from 50-60% of the polymerizable materials are crosslinked. The polymer may be electroluminescent. The polymer may be aligned. The polymer may emit polarized light upon excitation, which is preferably linear polarized light. The novel, polymeric light emitting or charge transporting materials may, further comprise: a linear polarizer, wherein the linear polarizer has a polarization axis substantially aligned with a polarization of the linear polarized light.

The novel, polymeric light emitting, or charge transporting materials may, further comprise: photoactive dyes. The dye, preferably comprises: a dichroic or pleachroic dye. Examples include anthraquinone dyes or tetralines, including those described in S. M. Kelly, Flat Panel Displays: Advanced Organic Materials, RSC Materials Monograph, ed. J. A. Connor, [2000]. Different dopant types may be used to obtain different pixel colors.

In another aspect, the polymeric light emitting or charge transporting materials disclosed herein may also be prepared by copolymerization of mixtures of reactive compounds. These mixtures may include two, three, four, or more reactive compounds disclosed herein. Examples of these mixtures include, but are not limited to,
(a) a mixture of first and second reactive non-mesogenic compounds each having the formula: C—(S-D)ₙ, wherein the first and second compounds are different; (b) a mixture of first, second, and third reactive non-mesogenic compounds each having the formula: C—(S-D)ₙ, wherein the first, second, and third compounds are different; (c) a mixture of first, second, third, and fourth reactive non-mesogenic compounds each having the formula: C—(S-D)ₙ, wherein the first, second, third, and fourth compounds are different; (d) a mixture of first and second reactive discotic compounds each having the formula: C—(S-D₁)ₙ, wherein the first and second compounds are different; (e) a mixture of first, second, and third reactive discotic compounds each having the formula: C—(S-D₁)ₙ, wherein the first, second, and third compounds are different; (f) a mixture of first, second, third, and fourth reactive discotic compounds each having the formula: C—(S-D₁)ₙ, wherein the first, second, third, and fourth compounds are different; (g) a mixture of first and second reactive oligomeric or polymeric compounds each having the formula: —[Ar¹—(S-D)_{q}]ₙ-[Ar²—(S-D)ₚ]ₘ-, wherein the first and second compounds are different; (h) a mixture of first, second, and third reactive oligomeric or polymeric compounds each having the formula: —[Ar¹—(S-D)_{q}]ₙ-[Ar²—(S-D)ₚ]ₘ-, wherein the first, second, and third compounds are different; and, (i) a mixture of first, second, third, and fourth reactive oligomeric or polymeric compounds each having the formula: —[Ar¹—(S-D)_{q}]ₙ—[Ar²-(S-D)ₚ]ₘ-, wherein the first, second, third, and fourth compounds are different. Alternatively, the copolymerization mixtures may include one or more reactive compounds disclosed herein and one or more other reactive compounds (e.g., the reactive mesogens of US2003/0099785, the contents of which are incorporated herein by reference). This may be advantageous in that eutectic or near eutectic mixtures of the reactive compounds may be prepared that are isotropic liquids or discotic fluids at room temperature. Liquids or fluids of these types are less likely to crystallize into solids before or after polymerization. Crystallization creates defect structures that greatly diminish the utility of OLED materials. Also, polymerization in a liquid or fluid phase may occur at lower UV doses and with higher crosslink conversion. Preferably, the copolymerization mixtures polymerize faster than the rates at which the individual components polymerization. More preferably, the copolymerization mixtures photopolymerize faster than the rates at which the individual components photopolymerization.

For example, equal parts of the four compounds, derived from Compound XI with S₂ is -butane-1,4-diyl; n-pentane-1,5-diyl; n-nonane-1,9-diyl; and n-decane-1,10-diyl; M═Pt; X₁═O; Y═CO₂; and, D₁=1,4-pentadien-3-yl yields a mixture with a low crystal to discotic transition temperature that may be photocrosslinked to a polymeric solid with discotic order. As another example, equal parts of compounds VIIa, VIIb, and VIIc may be mixed together to form a low melting mixture and crosslinked by irradiation with the 325 nm radiation from a helium cadmium laser to yield a light emitting polymer with a highly homogenous structure.

Reactive compounds of this invention may also be copolymerized with other reactive compounds including reactive calamitic mesogens. In this aspect, the polymer formed may have a calamitic liquid crystalline structure. The material may have an aligned calamitic liquid crystalline structure. The material may be light emitting, preferably polarized light. A preferred reactive mesogen for copolymerization has the formula:
B—S-A-S—B
wherein:
A is a chromophore;
each S is independently a spacer; and,
each B is independently an endgroup that is susceptible to photopolymerization.

Chromophore A may be an aryl substituted fluorene, wherein from 0-2 hydrogen atoms on chromophore A are replaced by a group selected from deuterium, F, and CH₃ and wherein the aryl substituents are located between the chromophore and each spacer S. Aryl substituted fluorene is intended to mean that the fluorene unit is substituted with 2 first aromatic rings, which are independently selected from phenyl, naphthyl, and 5-10 membered aromatic heterocycles consisting of carbon atoms and 0-4 heteroatoms selected from O, S, and NH. Examples of heterocycles include, but are not limited to, thienyl, pyridyl, pyridazinyl, pyrimidinyl, pyrazinyl, and triazinyl. Preferably, the first aromatic rings are phenyl or thienyl. It is also preferable that the first aromatic rings are themselves independently substituted with a second aromatic ring and spacers S are each independently attached to the second aromatic rings. The second aromatic rings are independently selected from phenyl, naphthyl, and 5-10 membered aromatic heterocycles consisting of carbon atoms and 0-4 heteroatoms selected from O, S, and NH. Preferably, the second aromatic rings are phenyl or thienyl. It is also preferably that the second aromatic rings are independently substituted with a third aromatic ring and spacers S are each independently attached to the third aromatic rings. The third aromatic rings are independently selected from phenyl, naphthyl, and 5-10 membered aromatic heterocycles consisting of carbon atoms and 0-4 heteroatoms selected from O, S, and NH. Preferably, the third aromatic rings are phenyl or thienyl. The aryl substituted fluorene may be substituted with 0-2 groups selected from C₁₋₁₂ alkyl (branched or linear), C₁₋₁₂ alkenyl (branched or linear), and C₁₋₁₂ alkoxy (linear or branched). Spacer S may be an alkylene (linear or branched) or alkenylene (linear or branched) group having 2, 3, 4, 5, 6, 7, 8, 9, 10, 11, 12, 13, 14, or 15 carbon atoms. From 0, 1, 2, to 3 of the carbon atoms of spacer S are replaced by a heteroatom selected from O, S, and NR, wherein R is selected from H, CH₃, C₂H₅, n-C₃H₇, and i-C₃H₇, preferably CH₃, C₂H₅, n-C₃H₇, and i-C₃H₇. From 0, 1, to 2 carbon atoms of spacer S may be substituted by a carbonyl group. Endgroup B may be a non-conjugated diene, preferably selected from:

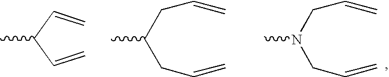

As an example, a mixture of 10% by weight compound XV, r is 50 on average, 45% by weight of compound XVI, and 45% by weight of compound XVII may be solvent cast and crosslinked using 325 nm UV radiation to form an intractable light emitting polymer film with liquid crystalline order.

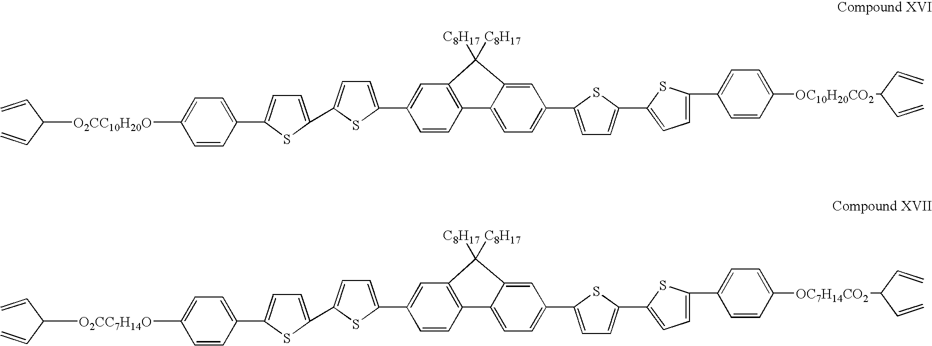

In this aspect of the invention compound XV is useful for modifying the rheology of the reactive mesogen solutions to be solvent cast. Such rheological modification may be highly useful, for example, in the formulation of solutions for ink jet printing of emitting layers and charge carrier transport layers.

The novel, polymeric light emitting, or charge transporting materials may be pixellated. The pixels may be of different colors, preferably red, green, and blue. The polymer may also be pixellated into pixels of different polarization directions. Pixellation of the light emitter may be achieved by selective photopatterning to produce red, green and blue pixels as desired. The pixels typically have a size of from 1 to 500 μm. In microdisplays, the pixels may have a size of from 1, 2, 3, 4, 5, 6, 7, 8, 9, 10, 15, 20, 25, 30, 35, 40, 45, to 50 μm, preferably from 5, 6, 7, 8, 9, 10, 11, 12, 13, 14, to 15 μm, even more preferably from 8, 9, to 10 μm. In other displays, the pixel size is typically larger with a size of about 300 μm being typical. Pixel color may also be influenced by the choice of chromophore with different chromophores having more suitability as red, green, or blue pixels.

In another aspect, the present invention provides a novel device, comprising: a material layer of the present invention. The device may be selected from an electronic device, a light emitting device, an organic light emitting device, a lighting element, a photovoltaic cell, and a laser. This aspect also includes a process, comprising: applying a material to a surface and then photopolymerizing the material in situ to form a polymeric layer. A useful method of applying the photopolymerizable materials is by spin-coating. Preferably, the surface is an inert substrate (e.g., glass or plastic). Particularly useful substrates are glass, indium tin oxide coated glass, an alignment layer coated over glass, and an alignment layer coated over an indium tin oxide coated glass. Layer thicknesses are typically in the range of 10, 20, 30, 40, 50, 100, 150, 200, 250, 300, 350, 400, 450, to 500 nm and are preferably in the range of 20, 30, 40, 50, 60, 70, 80, 90, 100, 110, 120, 130, 140, 150, 160, 170, 180, 190, to 200 nm. The devices may further comprise: additional layers including, but not limited to a light emitting layer, hole transport layer, electron transport layer, and a photoalignment layer. When the material of the present invention comprises a charge transport compound, then it is preferable to have a light emitting layer present. When the material of the present invention comprises a light emitting compound, then it is preferable to have a charge transport layer present. This aspect may also include a device, comprising: a photopolymerizable material applied over a photoalignment layer (e.g., the surface is a photoalignment layer), and the process for forming the same. This could be the case, for example, when mixtures of the reactive compounds of the present invention and reactive calamitic mesogens are used to give a composite material that shows a calamitic phase. This aspect may also include a device, comprising: a photopolymerizable material applied over a photoalignment layer (e.g., the surface is a photoalignment layer), which in turn is applied over an indium tin oxide coated glass, and the process for forming the same. The photoalignment layer may, further comprise: a transport compound (e.g., ion transport, hole transport, or electron transport), if desired.

FIG. 1 illustrates an exemplary device 100 including transport layers and an emissive layer. In FIG. 1, the device 100 includes a transparent substrate 102, an anode 104, a hole injection layer 106, a hole transport layer 108, an emissive layer 110, an electron transport layer 112, an electron injection layer 114, and a reflective cathode 116. The anode 104, hole injection layer 106, hole transport layer 108, emissive layer 110, electron transport layer 112, electron injection layer 114, and reflective cathode 116 form an organic light emitting device (OLED) 118. The anode 104 may be made from indium-tin oxide or another suitable transparent, conductive material. The cathode 116 may be made from a reflective, low work function metal such as aluminum, magnesium/silver alloy, calcium, or another suitable material. Alternatively, the device may be transmissive. The materials disclosed herein may be used to form, for example, one or more of the hole transport layer 108, the emissive layer 110, and the electron transport layer 112. The other layers may be formed from any of the suitable materials that are known in the art. Alternatively, additional layers, such as a photoalignment layer, may be included in the device 100 and one or more of the illustrated layers may be omitted.

In another aspect, the present invention provides a novel multicolor emitter, comprising: arrangements or sequences of different pixel colors. One suitable multicolor emitter, comprises: stripes of red, green, and blue pixels having the same polarization state. This may be used as a sequential color backlight for a display which allows the sequential flashing of red, green, and blue lights. Such backlights may be used in transmissive Ferroelectric Liquid Crystal (FLC) displays where the FLC acts as a shutter for the flashing colored lights. Alternatively, the shutter may be formed from other kinds of liquid crystal materials or may be used formed from non-liquid crystalline materials. Another suitable multicolor emitter, comprises: a full color pixellated display in which the component pixels thereof have the same or different alignment. Suitable multicolor emitters may be formed by a sequential “coat, selective cure, wash off” procedure in which a first color emitter is applied to an aligned layer by a suitable coating process (e.g. spin coating). The coated first color emitter is then selectively cured only where pixels of that color are to be formed. The residue (of uncured first color emitter) is then washed off. A second color emitter is then applied to the aligned layer, cured only where pixels of that color are required, and the residue washed off. If desired, a third color may be applied by repeating the procedure for the third color. This procedure may be used to form a pixellated display such as for use in a color emissive display. This procedure is simpler than traditional printing (e.g. ink jet) methods of forming such displays.

Although several embodiments of the present invention and its advantages have been described in detail, it should be understood that changes, substitutions, transformations, modifications, variations, permutations, and alterations may be made therein without departing from the teachings of the present invention or the spirit and scope of the invention being set forth by the appended claims.

1. A charge transporting or light emitting polymerizable material, comprising: a reactive non-mesogenic compound of the following formula:
C—(S-D)ₙ
wherein:
C is a chromophore;
S is a spacer;
D is a non-conjugated diene susceptible to photopolymerization; and,
n is selected from 1-10.

2. The polymerizable material of claim 1, wherein chromophore C is selected from: aryl substituted fluorene; 4,4′,4″-tris[N-(1-naphthyl)-N-phenyl-amino]triphenylamine; and, bis-triphenylamine, wherein from 0-2 hydrogen atoms on chromophore C are replaced by a group selected from deuterium, F, and CH₃.

3. The polymerizable material of claim 1, wherein:
spacer S is selected from a C₂₋₁₅ alkylene group and a C₂₋₁₅ alkenylene group;
from 0-3 carbon atoms of spacer S are independently replaced by a heteroatom selected from O, S, and NR, wherein R is selected from H, CH₃, C₂H₅, n-C₃H₇, and i-C₃H₇; and,
from 0-2 carbon atoms of spacer S are independently substituted by a carbonyl group.

4. The polymerizable material of claim 1, wherein diene D is selected from: 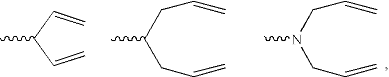
provided that D forms other than an O—N, S—N, or N—N bond with spacer S.

5. The polymerizable material of claim 1, wherein n is selected from 2, 3, 4, 5, and 6.

6. The polymerizable material of claim 1, wherein the reactive non-mesogenic compound has the formula: 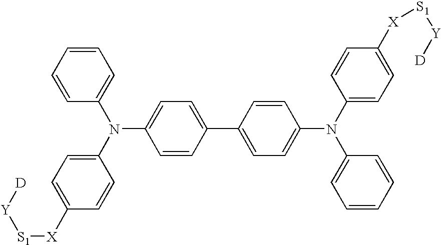
wherein:
each X is independently selected from CH₂O, CH₂, and CH₂NR, wherein R is selected from H, CH₃, C₂H₅, n-C₃H₇, and i-C₃H₇;
each S₁ is independently selected from a C₂₋₁₁ alkylene group and a C₂₋₁₁ alkenylene group;
each Y is independently selected from CH₂, O, CO₂, and S; and,
each D is independently selected from: 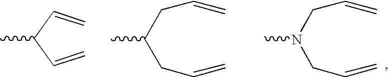
provided that D forms other than an O—N, S—N, or N—N bond with spacer S.

7. The polymerizable material of claim 6, wherein X—S₁—Y-D is selected from:

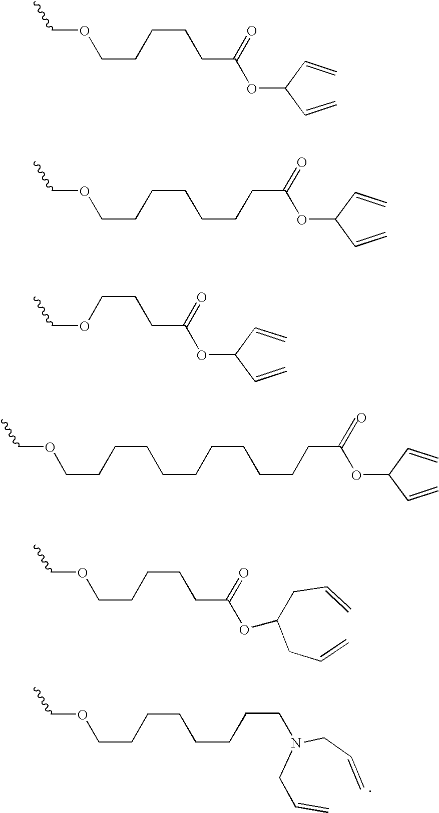

8. The polymerizable material of claim 6, wherein the reactive non-mesogenic compound is:

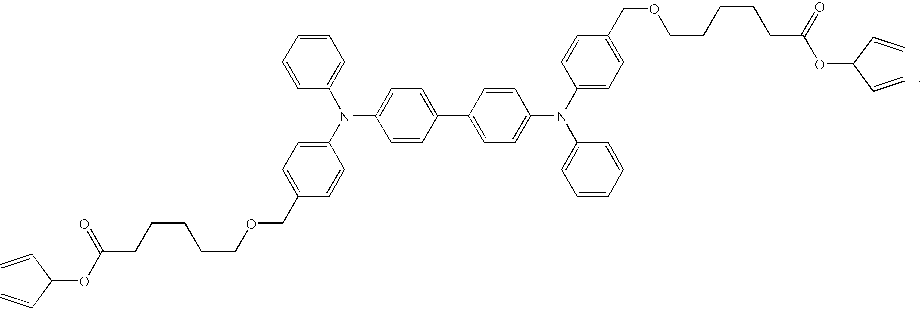

9. The polymerizable material of claim 1, wherein the reactive non-mesogenic compound has the formula: 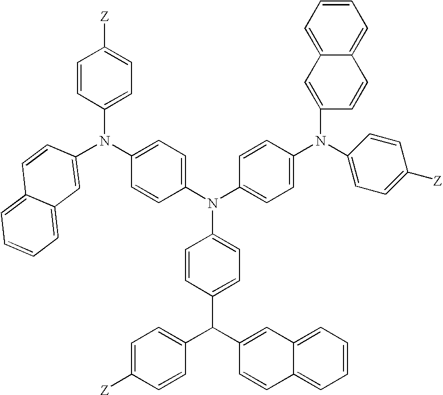
wherein:
each Z is independently selected from X—S₁—Y-D and H, provided that only one Z is H;
each X is independently selected from CH₂O, CH₂, and CH₂NR, wherein R is selected from H, CH₃, C₂H₅, n-C₃H₇, and i-C₃H₇;
each S₁ is independently selected from a C₂₋₁₁ alkylene group and a C₂₋₁₁ alkenylene group;
each Y is independently selected from CH₂, O, CO₂, and S; and,
each D is independently selected from: 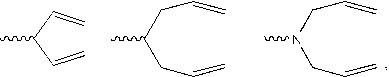
provided that D forms other than an O—N, S—N, or N—N bond with spacer S.

10. The polymerizable material of claim 9, wherein the reactive non-mesogenic compound is:

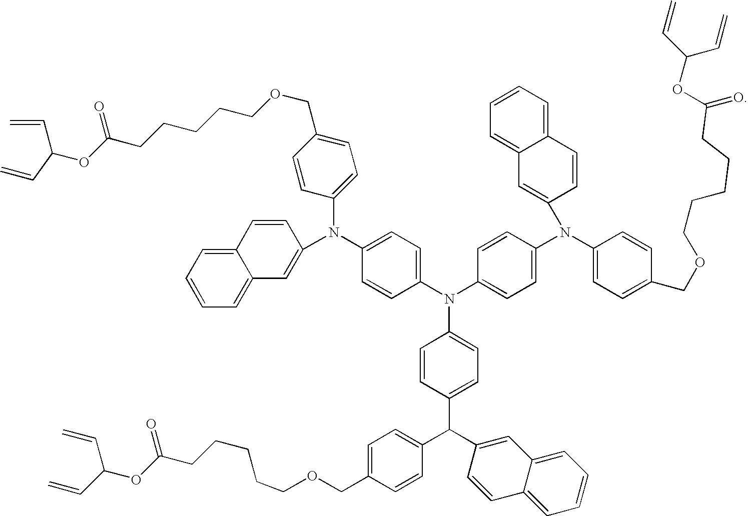

11. The polymerizable material of claim 1, wherein the reactive non-mesogenic compound has the formula: 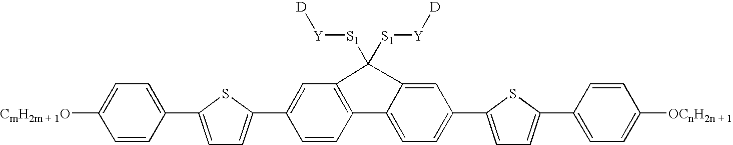
wherein:
each S₁ is independently selected from a C₂₋₁₁ alkylene group and a C₂₋₁₁ alkenylene group;
each Y is independently selected from CH₂, O, CO₂, and S;
each D is independently selected from: 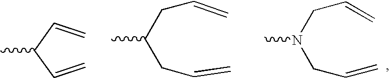
provided that D forms other than an O—N, S—N, or N—N bond with spacer S;
m is selected from 3-11; and,
n is selected from 3-11.

12. The polymerizable material of claim 11, wherein the S₁—Y-D group is selected from:

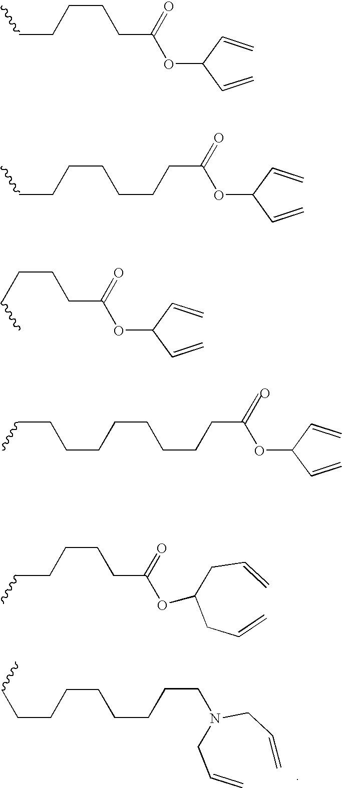

13. The polymerizable material of claim 11, wherein the reactive non-mesogenic compound is:

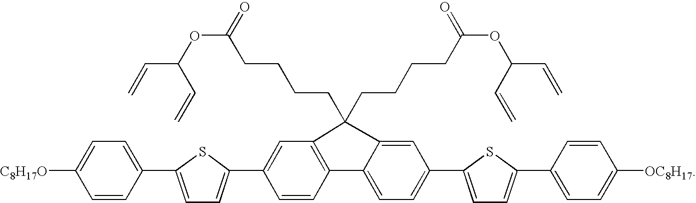

14. The polymerizable material of claim 11, wherein the reactive non-mesogenic compound has the formula: 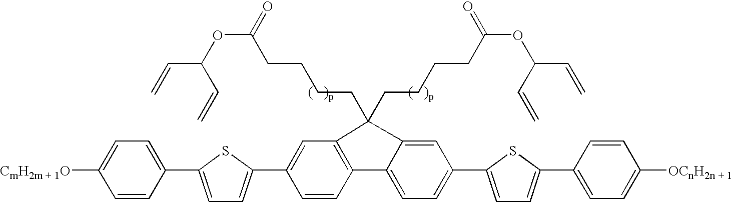
wherein n, m, and p are defined as follows:

| p | m | n |
|---|---|---|
| 2 | 8 | 8 |
| 4 | 8 | 8 |
| 8 | 8 | 8 |
| 1 | 3 | 3 |
| 1 | 4 | 4 |
| 1 | 5 | 5 |
| 1 | 6 | 6. |

15. The polymerizable material of claim 1, wherein the reactive non-mesogenic compound has the formula: 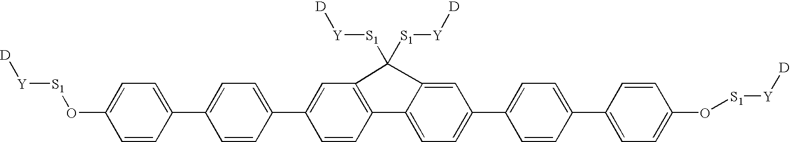
wherein:
each S₁ is independently selected from a C₂₋₁₁ alkylene group and a C₂₋₁₁ alkenylene group;
each Y is independently selected from CH₂, O, CO₂, and S; and,
each D is independently selected from: 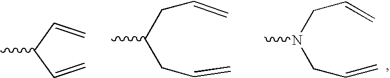
provided that D forms other than an O—N, S—N, or N—N bond with spacer S.

16. The polymerizable material of claim 15, wherein the reactive non-mesogenic compound is:

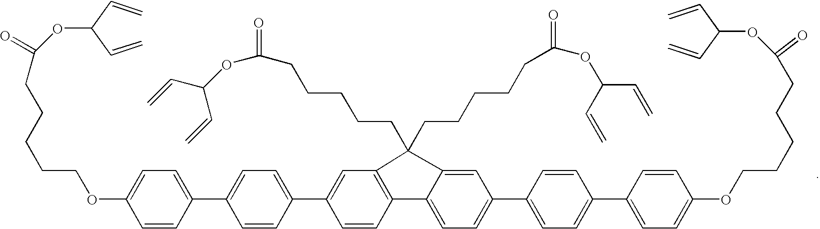

17. The polymerizable material of claim 15, wherein the reactive non-mesogenic compound has the formula: 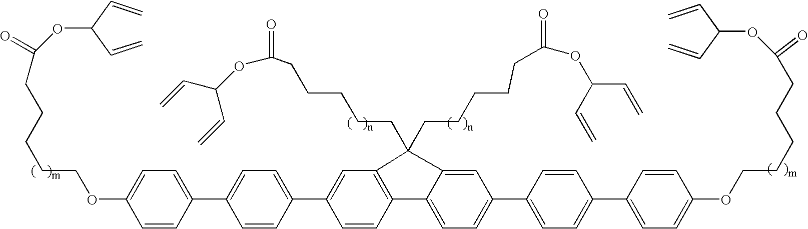
wherein n and m are defined as follows:

| n | m |
|---|---|
| 1 | 3 |
| 1 | 7 |
| 3 | 1 |
| 3 | 3 |
| 3 | 7 |
| 7 | 1 |
| 7 | 3 |
| 7 | 7. |

18. The polymerizable material of claim 1, wherein the reactive non-mesogenic compound has the formula: 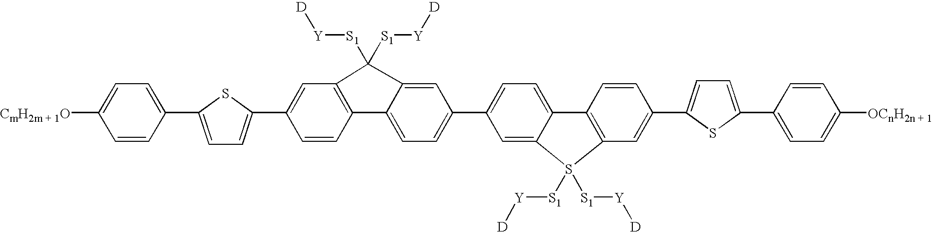
wherein
each S₁ is independently selected from a C₂₋₁₁ alkylene group and a C₂₋₁₁ alkenylene group;
each Y is independently selected from CH₂, O, CO₂, and S; preferably CO₂; and,
each D is independently selected from: 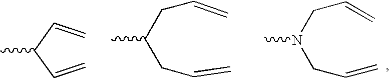
provided that D forms other than an O—N, S—N, or N—N bond with spacer S;
m is selected from 3, 4, 5, 6, 7, 8, 9, 10, and 11; and,
n is selected from 3, 4, 5, 6, 7, 8, 9, 10, and 11.

19. The polymerizable material of claim 1, wherein the reactive non-mesogenic compound has the formula:

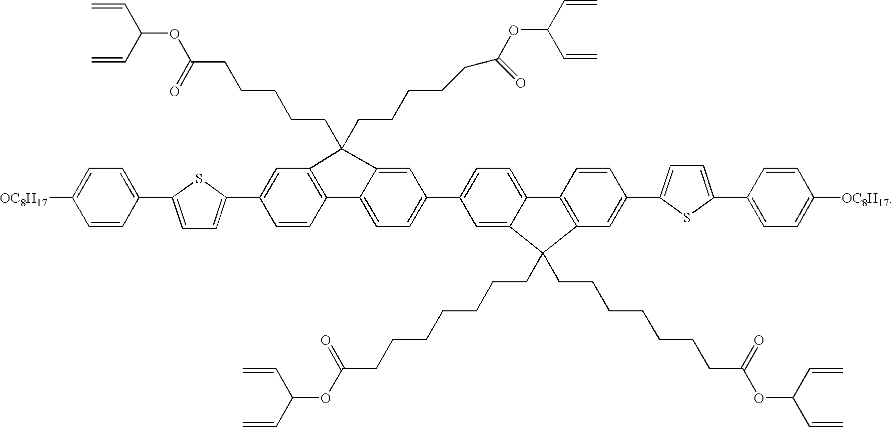

20. A light emitting polymerizable material, comprising: a reactive discotic compound having the following formula:
C—(S-D₁)ₙ
wherein:
C is a chromophore capable of forming a discotic liquid crystal;
S is a spacer;
D₁ is H or is a non-conjugated diene susceptible to photopolymerization, provided that at least 2 D₁ are other than H; and,
n is selected from 2-20.

21. The polymerizable material of claim 20, wherein chromophore C is a phthalocyanine.

22. The polymerizable material of claim 20, wherein chromophore C is a phthalocyanine bound to a metal.

23. The polymerizable material of claim 20, wherein chromophore C is a porphyrin.

24. The polymerizable material of claim 20, wherein chromophore C is a porphyrin bound to a metal.

25. The polymerizable material of claim 20, wherein:
spacer S is selected from a C₂₋₁₅ alkylene group and a C₂₋₁₅ alkenylene group;
from 0-3 carbon atoms of spacer S are independently replaced by a heteroatom selected from O, S, and NR, wherein R is selected from H, CH₃, C₂H₅, n-C₃H₇, and i-C₃H₇; and,
from 0-2 carbon atoms of spacer S are independently substituted by a carbonyl group.

26. The polymerizable material of claim 20, wherein diene D₁ is H or selected from: 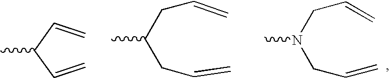
provided that D₁ forms other than an O—N, S—N, or N—N bond with spacer S, and further provided that at least 2 D₁ are other than H.

27. The polymerizable material of claim 20, wherein n is selected from 4-8.

28. The polymerizable material of claim 20, wherein the reactive discotic compound has the formula: 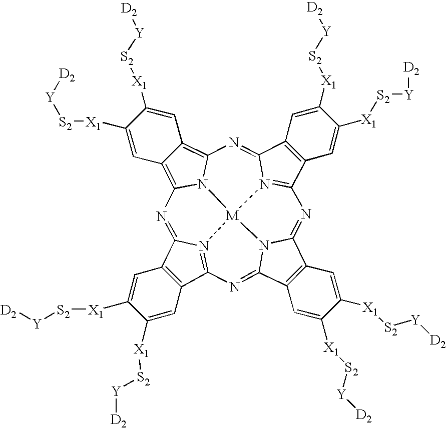
wherein:
M is a metal;
X₁ is selected from O, CH₂, and NR, wherein R is selected from H, CH₃, C₂H₅, n-C₃H₇, and i-C₃H₇;
each S₂ is independently selected from a C₂₋₁₂ alkylene group and a C₂₋₁₂ alkenylene group;
each Y is independently selected from CH₂, O, CO₂, and S; and,
each D₂ is independently C₁₋₆ alkyl or is selected from: 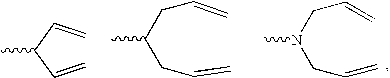
provided that D₂ forms other than an O—N, S—N, or N—N bond with spacer S, and further provided that at least two D₁ are other than alkyl.

29. The polymerizable material of claim 28, wherein X₁—S₂—Y-D₂ is selected from:

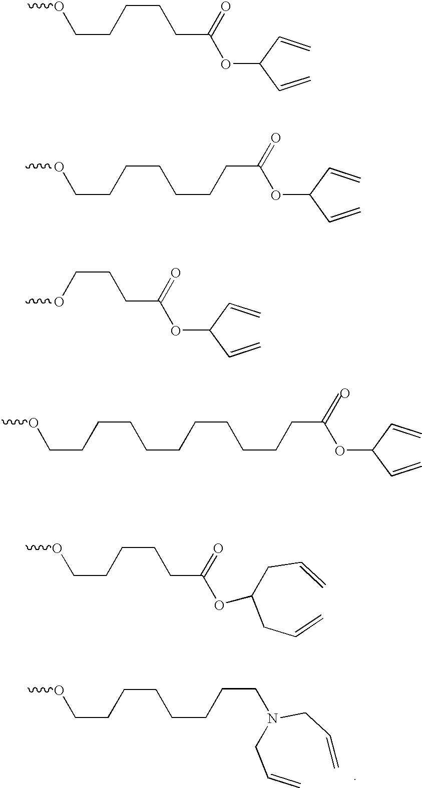

30. The polymerizable material of claim 28, wherein the reactive discotic compound is:

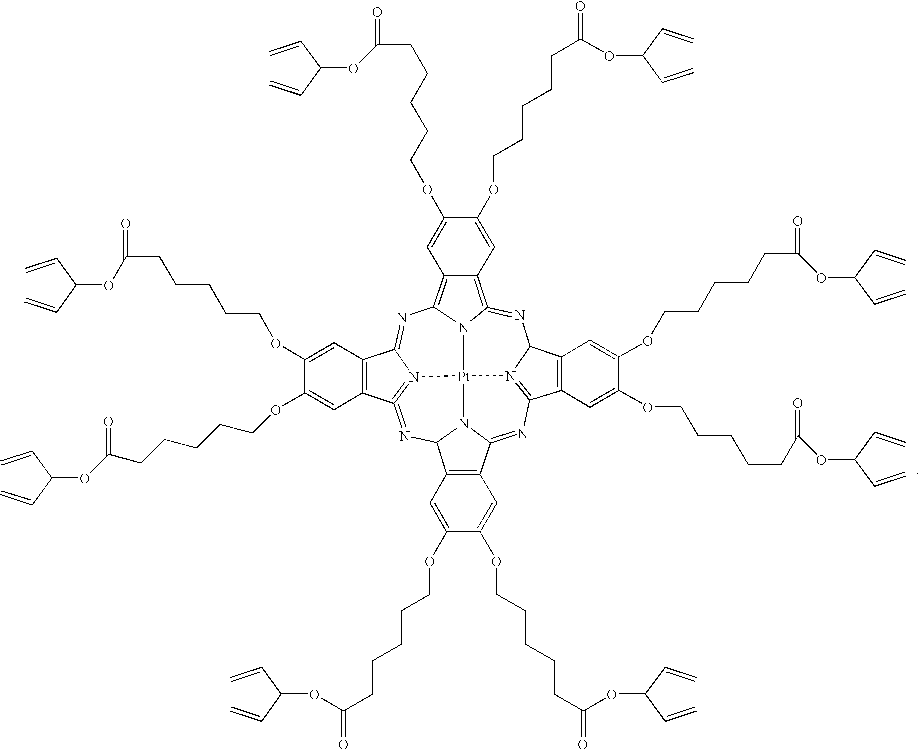

31. The polymerizable material of claim 28, wherein the reactive discotic compound has the formula:

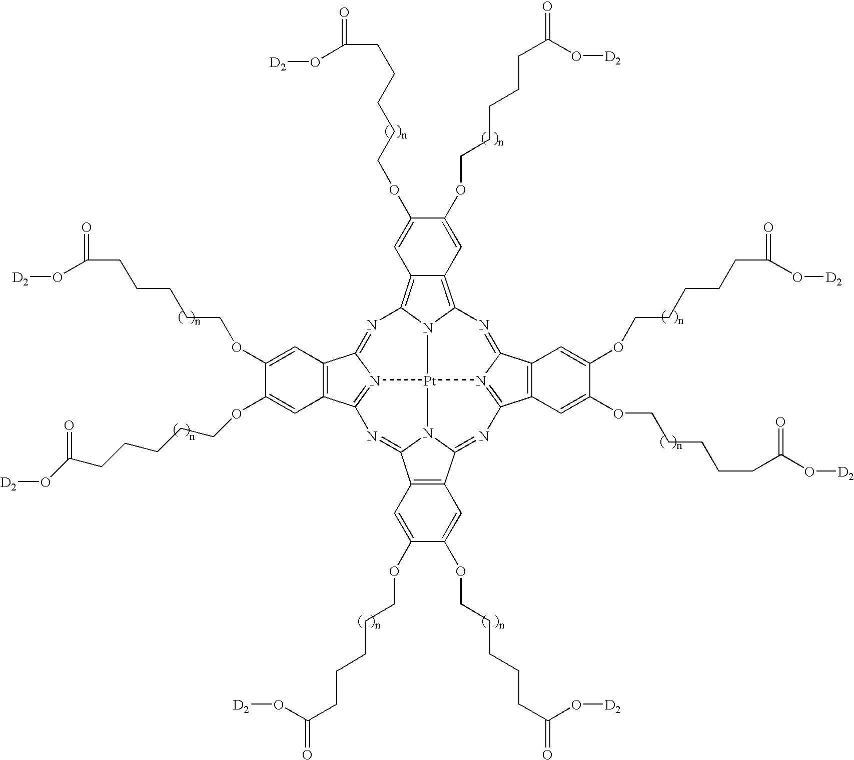

| n | D₂ |
|---|---|
| 1 | B |
| 1 | E |
| 2 | A |
| 2 | B |
| 2 | E |
| 3 | A |
| 3 | B |
| 3 | E |

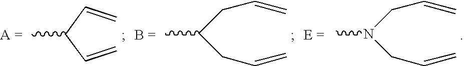

32. A light emitting polymerizable material, comprising: a reactive oligomeric or polymeric compound of the formula:
—[Ar¹—(S-D)_{q}]ₙ-[Ar²—(S-D)ₚ]ₘ-
wherein:
Ar¹ is a first aromatic group;
Ar² is a second aromatic group;
each S is independently a spacer;
each D is independently a non-conjugated diene susceptible to photopolymerization;
p is selected from 0-10;
q is selected from 0-10;
n is a mole fraction of [Ar¹—(S-D)_{q}] in the oligomeric or polymeric backbone of 0-90%;
m is a mole fraction of [Ar²—(S-D)ₚ] in the oligomeric or polymeric backbone of 100−n %; and,
there are 2-200 repeat units in the oligomeric or polymeric backbone;
provided that p+q total at least 1; and,
further provided that when n is 0 then p is other than 0.

33. The polymerizable material of claim 32, wherein Ar¹ and Ar² are selected from fluoren-diyl and bithien-diyl

34. The polymerizable material of claim 32, wherein:
spacer S is selected from a C₂₋₁₅ alkylene group and a C₂₋₁₅ alkenylene group;
from 0-3 carbon atoms of spacer S are independently replaced by a heteroatom selected from O, S, and NR, wherein R is selected from H, CH₃, C₂H₅, n-C₃H₇, and i-C₃H₇; and,
from 0-2 carbon atoms of spacer S are independently substituted by a carbonyl group.

35. The polymerizable material of claim 32, wherein diene D is selected from: 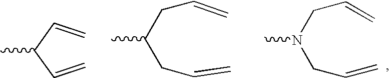
provided that D forms other than an O—N, S—N, or N—N bond with spacer S.

36. The polymerizable material of claim 32, wherein the reactive oligomeric or polymeric compound has the formula: 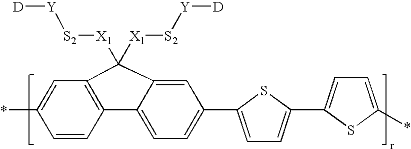
wherein:
X₁ is selected from O, CH₂, and NR, wherein R is selected from H, CH₃, C₂H₅, n-C₃H₇, and i-C₃H₇;
each S₂ is independently selected from a C₂₋₁₂ alkylene group and a C₂₋₁₂ alkenylene group;
each Y is independently selected from CH₂, O, CO₂, and S;
each D is independently selected from: 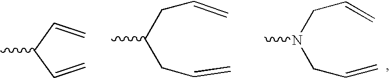
provided that D forms other than an O—N, S—N, or N—N bond with spacer S;
each * is independently selected from H, OH, C₁₋₁₂ alkyl, C₁₋₁₂ alkoxy, and X₁—S₂—Y-D; and,
r is selected from 2-100.

37. The polymerizable material of claim 36, wherein X₁—S₂—Y-D is selected from:

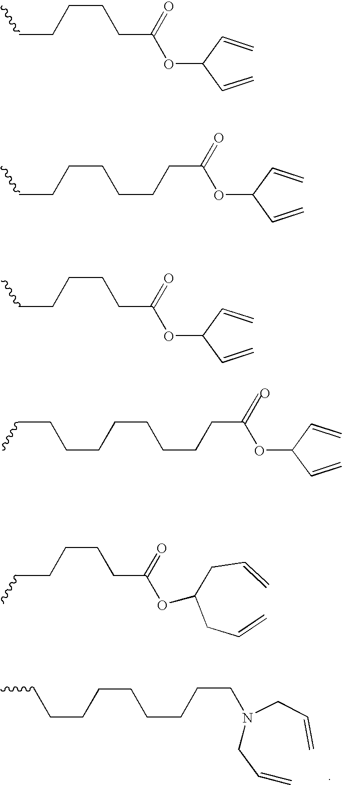

38. The polymerizable material of claim 36, wherein the compound has the formula: 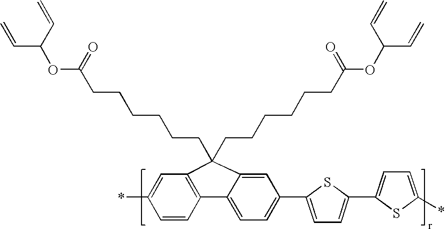
wherein:
each * is independently selected from H, OH, C₁₋₂ alkyl, C₁₋₁₂ alkoxy, and 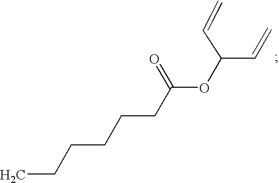
and,
r is selected from 20-50.

39. A charge transporting or light emitting material, comprising: a polymer formed from a reactive non-mesogenic compound of the following formula:
C—(S-D)ₙ
wherein:
C is a chromophore;
S is a spacer;
D is a non-conjugated diene susceptible to photopolymerization; and,
n is selected from 1-10.

40. The material of claim 39, wherein chromophore C is selected from: aryl substituted fluorene; 4,4′,4″-tris[N-(1-naphthyl)-N-phenyl-amino]triphenylamine; and, bis-triphenylamine, wherein from 0-2 hydrogen atoms on chromophore C are replaced by a group selected from deuterium, F, and CH₃.

41. The material of claim 39, wherein:
spacer S is selected from a C₂₋₁₅ alkylene group and a C₂₋₁₅ alkenylene group;
from 0-3 carbon atoms of spacer S are independently replaced by a heteroatom selected from O, S, and NR, wherein R is selected from H, CH₃, C₂H₅, n-C₃H₇, and i-C₃H₇; and,
from 0-2 carbon atoms of spacer S are independently substituted by a carbonyl group.

42. The material of claim 39, wherein diene D is selected from: 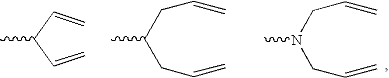
provided that D forms other than an O—N, S—N, or N—N bond with spacer S.

43. The material of claim 39, wherein n is selected from 2, 3, 4, 5, and 6.

44. The material of claim 39, wherein the polymer is formed by photopolymerization.

45. The material of claim 39, wherein the polymer is substantially photoinitiator free.

46. The material of claim 39, wherein the polymer is an insoluble, cross-linked network.

47. The material of claim 39, wherein the polymer is electroluminescent.

48. The material of claim 39, wherein the polymer, further comprises: photoactive dyes.

49. The material of claim 39, wherein the polymer is pixellated.

50. The material of claim 39, wherein the polymer is pixellated into pixels of different colors.

51. The material of claim 50, wherein the different colors are red, green, and blue.

52. The material of claim 39, wherein the polymer is pixellated into pixels of different polarization directions.

53. The material of claim 39, wherein the polymer is aligned.

54. The material of claim 39, wherein the polymer emits polarized light upon excitation.

55. The material of claim 54, wherein the polarized light is linear polarized light.

56. The material of claim 55, further comprising: a linear polarizer, wherein the linear polarizer has a polarization axis substantially aligned with a polarization of the linear polarized light.

57. The material of claim 39, wherein the reactive non-mesogenic compound has the formula: 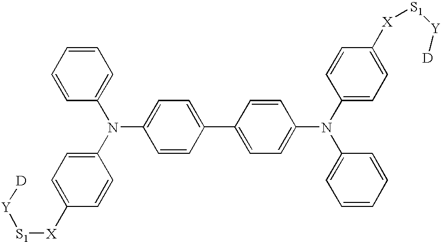
wherein:
each X is independently selected from CH₂O, CH₂, and CH₂NR, wherein R is selected from H, CH₃, C₂H₅, n-C₃H₇, and i-C₃H₇; each S₁ is independently selected from a C₂₋₁₁ alkylene group and a C₂₋₁₁ alkenylene group;
each Y is independently selected from CH₂, O, CO₂, and S; and,
each D is independently selected from: 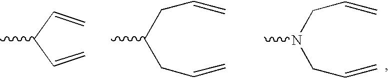
provided that D forms other than an O—N, S—N, or N—N bond with spacer S.

58. The material of claim 57, wherein X—S₁—Y-D is selected from:

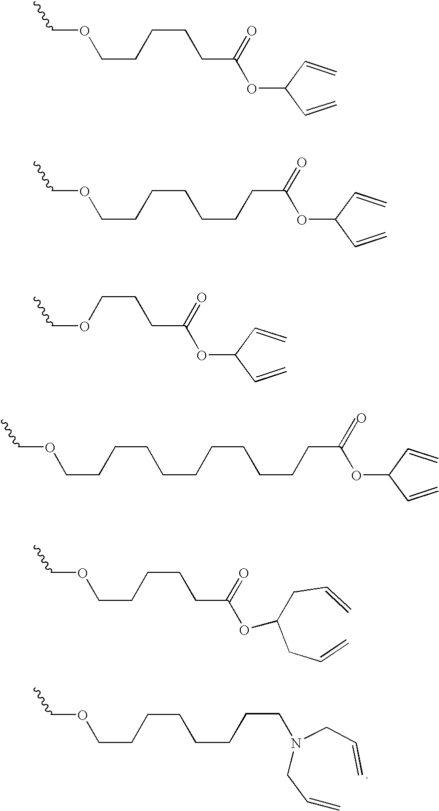

59. The material of claim 57, wherein the reactive non-mesogenic compound is:

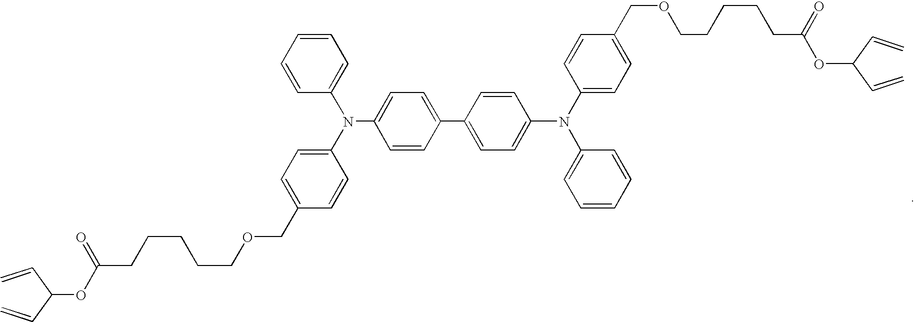

60. The material of claim 39, wherein the reactive non-mesogenic compound has the formula: 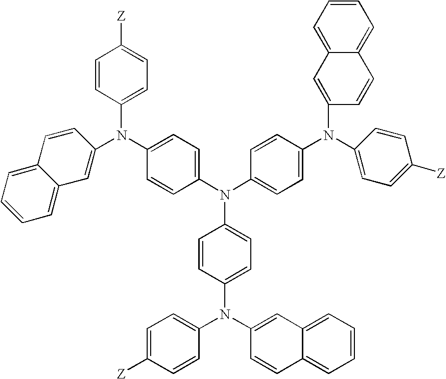
wherein:
each Z is independently selected from X—S₁—Y-D and H, provided that only one Z is H;
each X is independently selected from CH₂O, CH₂, and CH₂NR, wherein R is selected from H, CH₃, C₂H₅, n-C₃H₇, and i-C₃H₇;
each S₁ is independently selected from a C₂₋₁₁ alkylene group and a C₂₋₁₁ alkenylene group;
each Y is independently selected from CH₂, O, CO₂, and S; and,
each D is independently selected from: 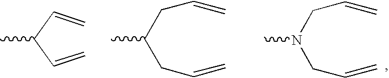
provided that D forms other than an O—N, S—N, or N—N bond with spacer S.

61. The material of claim 60, wherein the reactive non-mesogenic compound is:

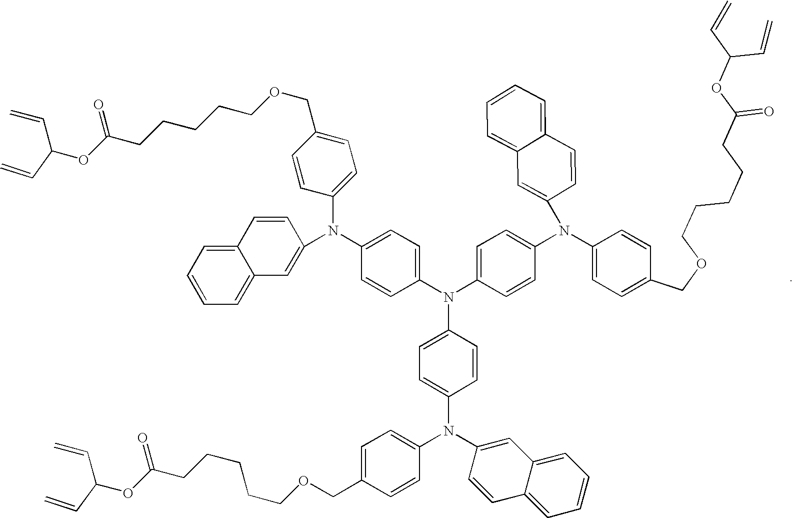

62. The material of claim 39, wherein the reactive non-mesogenic compound has the formula: 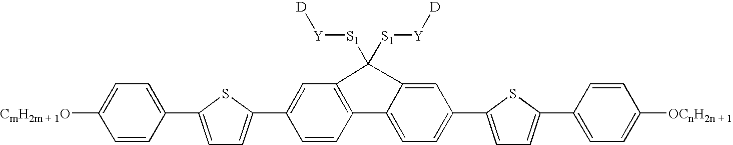
wherein:
each S₁ is independently selected from a C₂₋₁₁ alkylene group and a C₂₋₁₁ alkenylene group;
each Y is independently selected from CH₂, O, CO₂, and S;
each D is independently selected from: 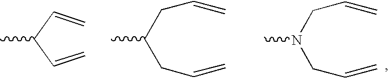
provided that D forms other than an O—N, S—N, or N—N bond with spacer S;
m is selected from 3-11; and,
n is selected from 3-11.

63. The material of claim 62, wherein the S₁—Y-D group is selected from:

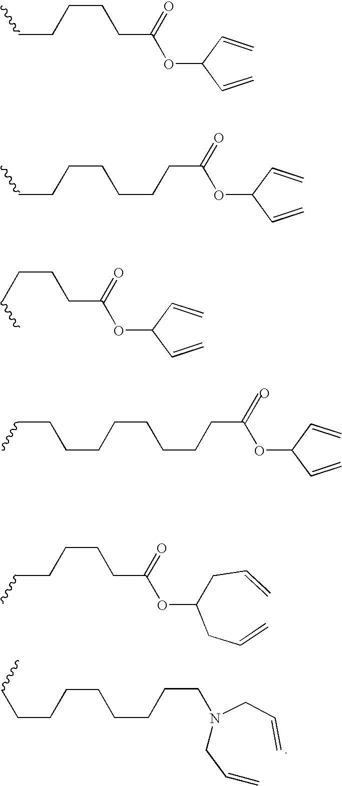

64. The material of claim 62, wherein the reactive non-mesogenic compound is:

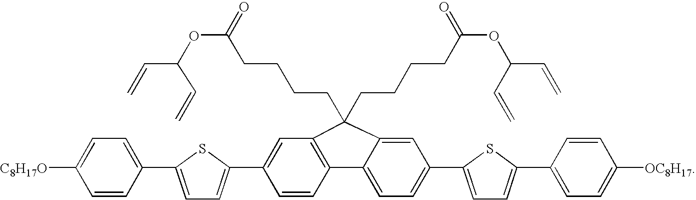

65. The material of claim 62, wherein the reactive non-mesogenic compound has the formula: 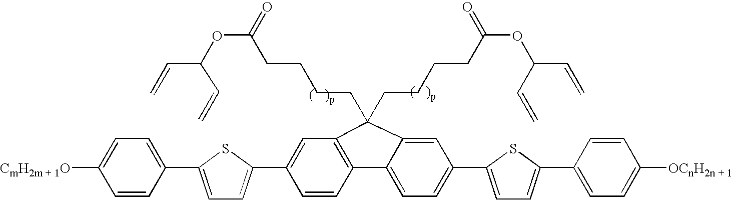
wherein n, m, and p are defined as follows:

| p | m | n |
|---|---|---|
| 2 | 8 | 8 |
| 4 | 8 | 8 |
| 8 | 8 | 8 |
| 1 | 3 | 3 |
| 1 | 4 | 4 |
| 1 | 5 | 5 |
| 1 | 6 | 6. |

66. The material of claim 39, wherein the reactive non-mesogenic compound has the formula: 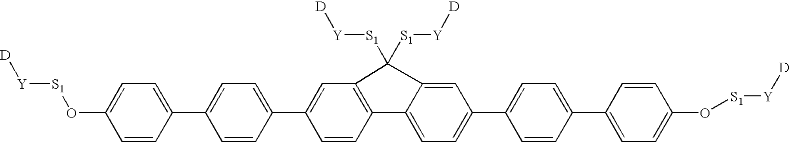
wherein:
each S₁ is independently selected from a C₂₋₁₁ alkylene group and a C₂₋₁₁ alkenylene group;
each Y is independently selected from CH₂, O, CO₂, and S; and,
each D is independently selected from: 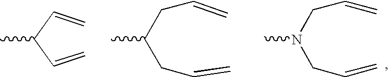
provided that D forms other than an O—N, S—N, or N—N bond with spacer S.

67. The material of claim 66, wherein the reactive non-mesogenic compound is:

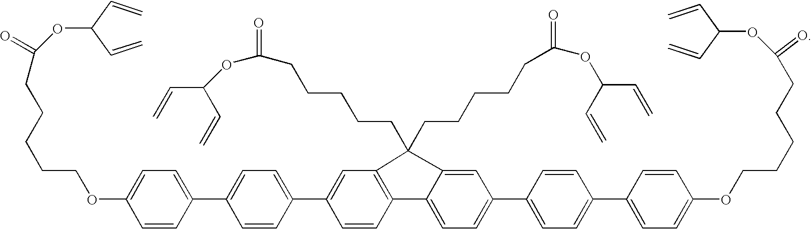

68. The material of claim 66, wherein the reactive non-mesogenic compound has the formula: 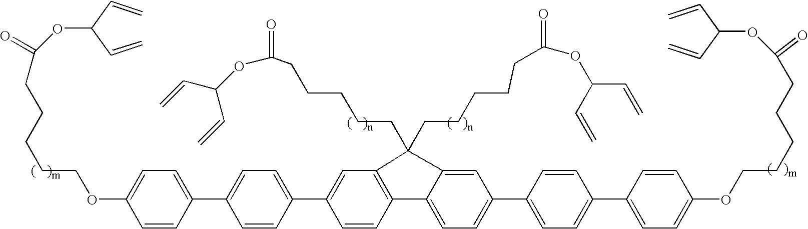
wherein n and m are defined as follows:

| n | m |
|---|---|
| 1 | 3 |
| 1 | 7 |
| 3 | 1 |
| 3 | 3 |
| 3 | 7 |
| 7 | 1 |
| 7 | 3 |
| 7 | 7. |

69. The material of claim 39, wherein the reactive non-mesogenic compound has the formula: 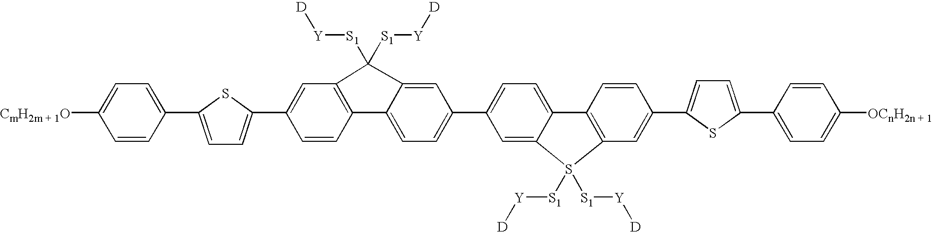
wherein:
each S₁ is independently selected from a C₂₋₁₁ alkylene group and a C₂₋₁₁ alkenylene group;
each Y is independently selected from CH₂, O, CO₂, and S; preferably CO₂; and,
each D is independently selected from: 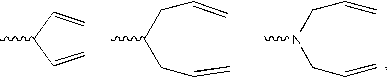
provided that D forms other than an O—N, S—N, or N—N bond with spacer S;
m is selected from 3-11; and,
n is selected from 3-11.

70. The polymerizable material of claim 1, wherein the reactive non-mesogenic compound has the formula:

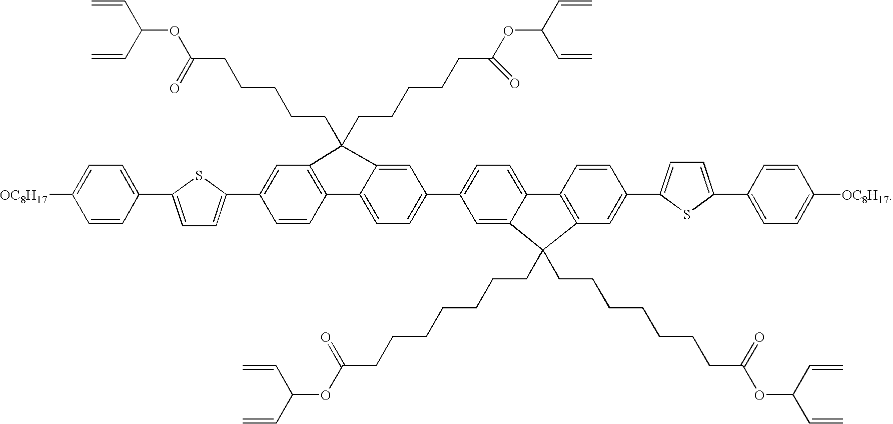

71. A light emitting material, comprising: a polymer formed from a reactive discotic compound having the following formula:
C—(S-D₁)ₙ
wherein:
C is a chromophore capable of forming a discotic liquid crystal;
S is a spacer;
D₁ is H or is a non-conjugated diene susceptible to photopolymerization, provided that at least 2 D₁ are other than H; and,
n is selected from 2-20.

72. The material of claim 71, wherein chromophore C is a phthalocyanine.

73. The material of claim 71, wherein chromophore C is a phthalocyanine bound to a metal.

74. The material of claim 71, wherein chromophore C is a porphyrin.

75. The material of claim 71, wherein chromophore C is a porphyrin bound to a metal.

76. The material of claim 71, wherein:
spacer S is selected from a C₂₋₁₅ alkylene group and a C₂₋₁₅ alkenylene group;
from 0-3 carbon atoms of spacer S are independently replaced by a heteroatom selected from O, S, and NR, wherein R is selected from H, CH₃, C₂H₅, n-C₃H₇, and i-C₃H₇; and,
from 0-2 carbon atoms of spacer S are independently substituted by a carbonyl group.

77. The material of claim 71, wherein diene D₁ is H or selected from: 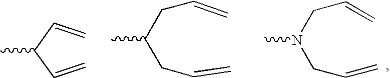
provided that D₁ forms other than an O—N, S—N, or N—N bond with spacer S, and further provided that at least 2 D₁ are other than H.

78. The material of claim 71, wherein n is selected from 4-8.

79. The material of claim 71, wherein the polymer is formed by photopolymerization.

80. The material of claim 71, wherein the polymer is substantially photoinitiator free.

81. The material of claim 71, wherein the polymer is an insoluble, cross-linked network.

82. The material of claim 71, wherein the polymer is electroluminescent.

83. The material of claim 71, wherein the polymer, further comprises:
photoactive dyes.

84. The material of claim 71, wherein the polymer is pixellated.

85. The material of claim 71, wherein the polymer is pixellated into pixels of different colors.

86. The material of claim 85, wherein the different colors are red, green, and blue.

87. The material of claim 71, wherein the polymer is pixellated into pixels of different polarization directions.

88. The material of claim 71, wherein the reactive discotic compound has the formula: 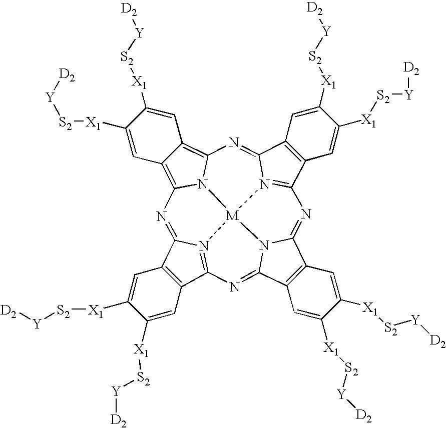
wherein:
M is a metal;
X₁ is selected from O, CH₂, and NR, wherein R is selected from H, CH₃, C₂H₅, n-C₃H₇, and i-C₃H₇;
each S₂ is independently selected from a C₂₋₁₂ alkylene group and a C₂₋₁₂ alkenylene group;
each Y is independently selected from CH₂, O, CO₂, and S; and,
each D₂ is independently C₁₋₆ alkyl or is selected from: 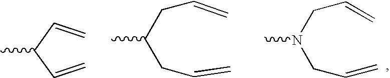
provided that D₂ forms other than an O—N, S—N, or N—N bond with spacer S, and further provided that at least two D₁ are other than alkyl.

89. The material of claim 88, wherein X₁—S₂—Y-D₂ is selected from:

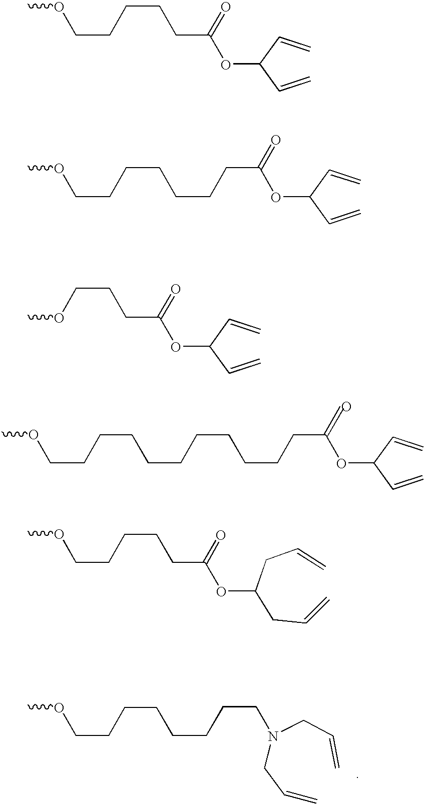

90. The material of claim 88, wherein the reactive discotic compound is:

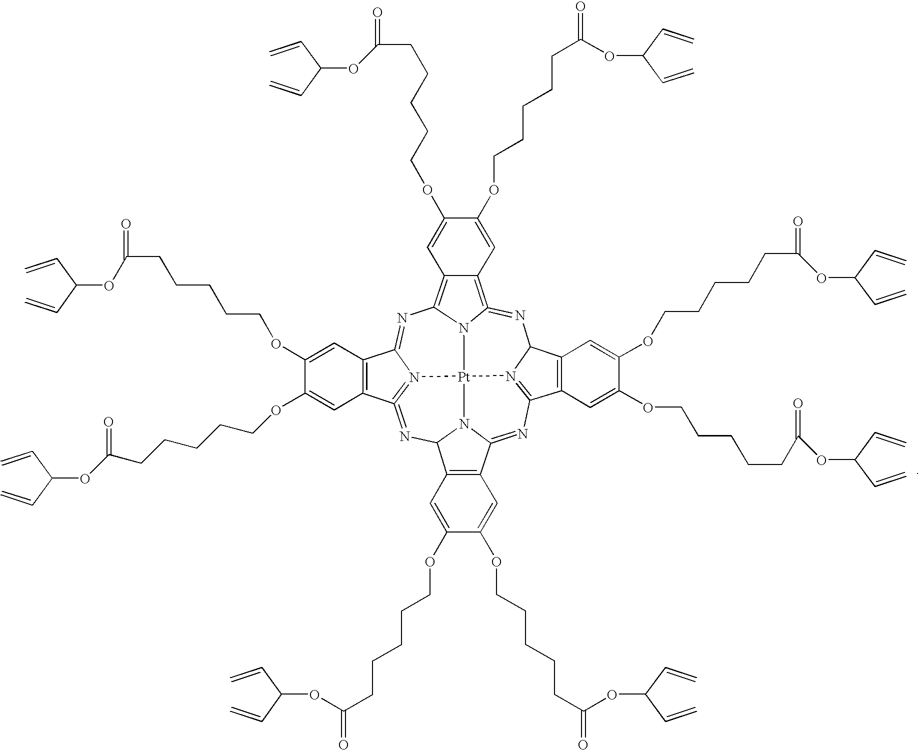

91. The material of claim 88, wherein the reactive discotic compound has the formula:

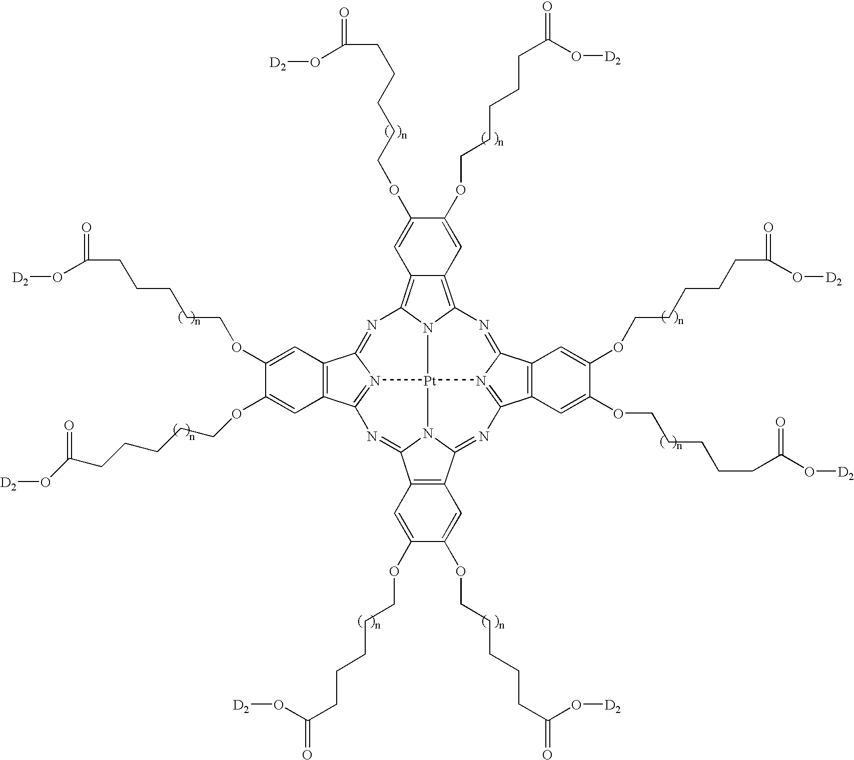

| n | D₂ |
|---|---|
| 1 | B |
| 1 | E |
| 2 | A |
| 2 | B |
| 2 | E |
| 3 | A |
| 3 | B |
| 3 | E |

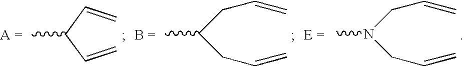

92. A light emitting material, comprising: a polymer formed from a reactive oligomeric or polymeric compound of the formula:
—[Ar¹—(S-D)_{q}]ₙ-[Ar²—(S-D)ₚ]ₘ-
wherein:
Ar¹ is a first aromatic group;
Ar² is a second aromatic group;
each S is independently a spacer;
each D is independently a non-conjugated diene susceptible to photopolymerization;
p is selected from 0-10;
q is selected from 0-10;
n is a mole fraction of [Ar¹—(S-D)_{q}] in the oligomeric or polymeric backbone of 0-90%;
m is a mole fraction of [Ar²—(S-D)ₚ] in the oligomeric or polymeric backbone of 100−n %; and,
there are 2-200 repeat units in the oligomeric or polymeric backbone;
provided that p+q total at least 1; and,
further provided that when n is 0 then p is other than 0.

93. The material of claim 92, wherein Ar¹ and Ar² are selected from fluoren-diyl and bithien-diyl.

94. The material of claim 92, wherein:
each spacer S is independently selected from a C₂₋₁₅ alkylene group and a C₂₋₁₅ alkenylene group;
from 0-3 carbon atoms of spacer S are independently replaced by a heteroatom selected from O, S, and NR, wherein R is selected from H, CH₃, C₂H₅, n-C₃H₇, and i-C₃H₇; and,
from 0-2 carbon atoms of spacer S are independently substituted by a carbonyl group.

95. The material of claim 92, wherein diene D is selected from: 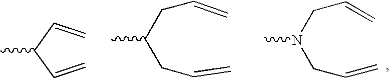
provided that D forms other than an O—N, S—N, or N—N bond with spacer S.

96. The material of claim 92, wherein the reactive oligomeric or polymeric compound has the formula: 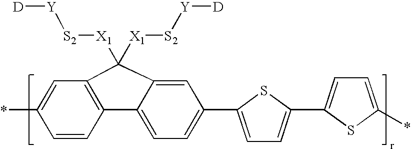
wherein:
each X₁ is independently selected from O, CH₂, and NR, wherein R is selected from H, CH₃, C₂H₅, n-C₃H₇, and i-C₃H₇;
each S₂ is independently selected from a C₂₋₁₂ alkylene group and a C₂₋₁₂ alkenylene group;
each Y is independently selected from CH₂, O, CO₂, and S;
each D is independently selected from: 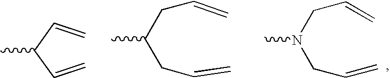
provided that D forms other than an O—N, S—N, or N—N bond with spacer S;
each * is independently selected from H, OH, C₁₋₁₂ alkyl, C₁₋₁₂ alkoxy, and X₁—S₂—Y-D; and,
r is selected from 2-100.

97. The material of claim 96, wherein X₁—S₂—Y-D is selected from:

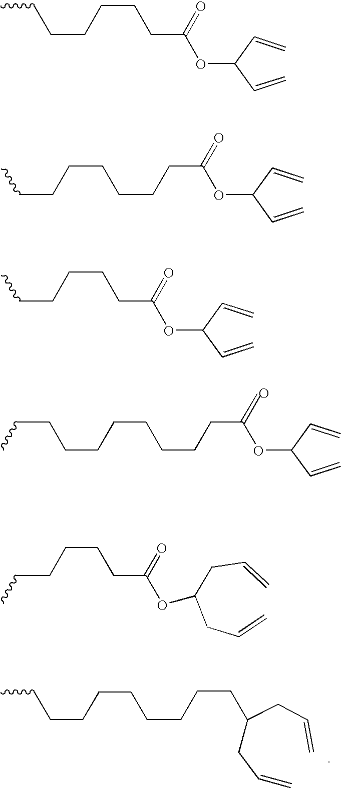

98. The material of claim 96, wherein the compound has the formula: 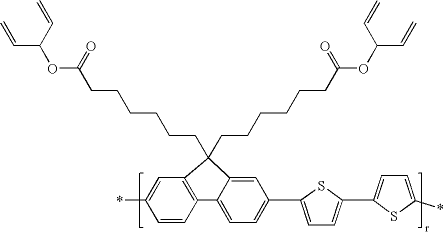
wherein:
each * is independently selected from H, OH, C₁₋₁₂ alkyl, C₁₋₁₂ alkoxy, and 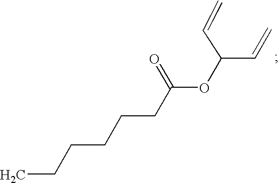
and,
r is selected from 20-50.

99. The material of claim 92, wherein the polymer is formed by photopolymerization.

100. The material of claim 92, wherein the polymer is substantially photoinitiator free.

101. The material of claim 92, wherein the polymer is an insoluble, cross-linked network.

102. The material of claim 92, wherein the polymer is electroluminescent.

103. The material of claim 92, wherein the polymer, further comprises: photoactive dyes.

104. The material of claim 92, wherein the polymer is pixellated.

105. The material of claim 92, wherein the polymer is pixellated into pixels of different colors.

106. The material of claim 105, wherein the different colors are red, green, and blue.

107. The material of claim 92, wherein the polymer is pixellated into pixels of different polarization directions.

108. The material of claim 92, wherein the polymer is aligned.

109. The material of claim 92, wherein the polymer emits polarized light upon excitation.

110. The material of claim 109, wherein the polarized light is linear polarized light.

111. The material of claim 110, further comprising: a linear polarizer, wherein the linear polarizer has a polarization axis substantially aligned with a polarization of the linear polarized light.

112. A process for forming charge transporting or light emitting materials, comprising: photopolymerizing a reactive non-mesogenic compound of claim 1.

113. The process of claim 112, wherein the photopolymerizing substantially occurs without a photoinitiator.

114. A process for forming charge transporting or light emitting materials, comprising: photopolymerizing a reactive discotic compound of claim 20.

115. The process of claim 114, wherein the photopolymerizing substantially occurs without a photoinitiator.

116. A process for forming charge transporting or light emitting materials, comprising: photopolymerizing a reactive oligomeric or polymeric compound of claim 32.

117. The process of claim 116, wherein the photopolymerizing substantially occurs without a photoinitiator.

118. A device, comprising: a material layer according to claim 39.

119. The device of claim 118, wherein the device is selected from: an electronic device, a light emitting device, an organic light emitting device, a lighting element, a photovoltaic cell, and a laser.

120. A device, comprising: a material layer according to claim 71.

121. The device of claim 120, wherein the device is selected from: an electronic device, a light emitting device, an organic light emitting device, a lighting element, a photovoltaic cell, and a laser.

122. A device, comprising: a material layer according to claim 92.

123. The device of claim 122, wherein the device is selected from: an electronic device, a light emitting device, an organic light emitting device, a lighting element, a photovoltaic cell, and a laser.

124. The material of claim 39, wherein the polymer is a copolymer formed with at least a second reactive non-mesogenic compound of the following formula:
C—(S-D)ₙ
wherein:
C is a chromophore;
S is a spacer;
D is a non-conjugated diene susceptible to photopolymerization;
n is selected from 1-10; and,
provided that the second reactive non-mesogenic compound is different from the first reactive non-mesogenic compound.

125. The material of claim 124, wherein the copolymer is formed with a least a third reactive non-mesogenic compound of the following formula:
C—(S-D)ₙ
wherein:
C is a chromophore;
S is a spacer;
D is a non-conjugated diene susceptible to photopolymerization;
n is selected from 1-10; and,
provided that the third reactive non-mesogenic compound is different from the first and second reactive non-mesogenic compounds.

126. The material of claim 39, wherein the polymer is a copolymer formed with at least a first reactive mesogenic compound of the following formula:
B—S-A-S—B
wherein:
A is a chromophore;
each S is independently a spacer; and,
each B is independently an endgroup that is susceptible to photopolymerization.

127. The material of claim 71, wherein the polymer is a copolymer formed from at least a second reactive discotic compound having the following formula:
C—(S-D ₁)ₙ
wherein:
C is a chromophore capable of forming a discotic liquid crystal;
S is a spacer;
D₁ is H or is a non-conjugated diene susceptible to photopolymerization, provided that at least 2 D₁ are other than H;
n is selected from 2-20; and,
provided that the second reactive discotic compound is different from the first reactive discotic compound.

128. The material of claim 127, wherein the polymer is a copolymer formed from at least a third reactive discotic compound having the following formula:
C—(S-D₁)ₙ
wherein:
C is a chromophore capable of forming a discotic liquid crystal;
S is a spacer;
D₁ is H or is a non-conjugated diene susceptible to photopolymerization, provided that at least 2 D₁ are other than H;
n is selected from 2-20; and,
provided that the third reactive discotic compound is different from the first and second reactive discotic compounds.

129. The material of claim 71, wherein the polymer is a copolymer formed with at least a first reactive mesogenic compound of the following formula:
B—S-A-S—B
wherein:
A is a chromophore;
each S is independently a spacer; and,
each B is independently an endgroup that is susceptible to photopolymerization.

130. The material of claim 92, wherein the polymer is a copolymer formed from at least a second reactive oligomeric or polymeric compound of the formula:
—[Ar¹—(S-D)_{q}]ₙ-[Ar²—(S-D)ₚ]ₘ-
wherein:
Ar¹ is a first aromatic group;
Ar² is a second aromatic group;
each S is independently a spacer;
each D is independently a non-conjugated diene susceptible to photopolymerization;
p is selected from 0-10;
q is selected from 0-10;
n is a mole fraction of [Ar¹—(S-D)_{q}] in the oligomeric or polymeric backbone of 0-90%;
m is a mole fraction of [Ar²—(S-D)ₚ] in the oligomeric or polymeric backbone of 100−n %; and,
there are 2-200 repeat units in the oligomeric or polymeric backbone;
provided that p+q total at least 1 and that when n is 0 then p is other than 0; and,
further provided that the second reactive oligomeric or polymeric compound is different from the first reactive oligomeric or polymeric compound.

131. The material of claim 130, wherein the polymer is a copolymer formed from at least a third reactive oligomeric or polymeric compound of the formula:
—[Ar¹—(S-D)_{q}]ₙ-[Ar²—(S-D)ₚ]ₘ-
wherein:
Ar¹ is a first aromatic group;
Ar² is a second aromatic group;
each S is independently a spacer;
each D is independently a non-conjugated diene susceptible to photopolymerization;
p is selected from 0-10;
q is selected from 0-10;
n is a mole fraction of [Ar¹—(S-D)_{q}] in the oligomeric or polymeric backbone of 0-90%;
m is a mole fraction of [Ar²—(S-D)ₚ] in the oligomeric or polymeric backbone of 100−n %; and,
there are 2-200 repeat units in the oligomeric or polymeric backbone;
provided that p+q total at least 1 and that when n is 0 then p is other than 0; and,
further provided that the third reactive oligomeric or polymeric compound is different from the first and second reactive oligomeric or polymeric compounds.

132. The material of claim 92, wherein the polymer is a copolymer formed with at least a first reactive mesogenic compound of the following formula:
B—S-A-S—B
wherein:
A is a chromophore;
each S is independently a spacer; and,
each B is independently an endgroup that is susceptible to photopolymerization.
